(19) United States
(12) Patent Application Publication
(10) Pub. No.: US 2016/0328432 A1
(43) Pub. Date: Nov. 10, 2016

(54) SYSTEM AND METHOD FOR MANAGEMENT OF TIME SERIES DATA SETS

(71) Applicant: Squigglee LLC, Katy, TX (US)

(72) Inventor: Ramesh Raghunathan, Katy, TX (US)

(21) Appl. No.: 14/705,653

(22) Filed: May 6, 2015

(51) Int. Cl. G06F 17/30

(52) U.S. Cl. CPC G06F 17/30333; G06F 17/30321

(57) ABSTRACT

This disclosure is directed to systems and methods of storing time series data sets, replicating the time series data sets across locations, indexing and sketching the time series incrementally, and fast retrieval of the time series data and/or their synopses. One aspect is a system managing a time series data including a plurality of time series data elements set using a time series manager. Each time series data element comprises a timestamp, a value, a context information, and a unique identifier. The time series manager is configured to define an index or sketch based on the defined time series data set. The index or sketch is used to identify matches, results or synopses of a query within the defined time series data set. The time series data may be updated causing the index or sketch to be updated and may provide a view configured to present information.

### BACKGROUND

1. Technology Field

The described technology generally relates to systems and methods used for the storage, replication, retrieval, and synopses for real-time and historical time series data. More specifically, this disclosure is directed to devices, systems, and methods related to storing one or more time series data sets, replicating the time series data sets across various locations, indexing and sketching the time series incrementally, and fast retrieval of the time series data and/or their synopses from any of the locations.

2. Description of the Related Technology

Current methods, technologies, and systems for the management of time series data reveal many gaps, shortcomings, and deficiencies. For example, these methods, technologies, and systems generally fail to provide support for storing, replicating, retrieving, and summarizing high frequency data with greater than millisecond resolution. Furthermore, existing methods, technologies, and systems often do not support multi-dimensional time series data queries and synopses. Additionally, for methods, technologies, and systems that may offer similar options, these options cannot be directly leveraged for real-time data sets and typically employ approaches that are too slow and ineffective for use with high frequency time series data sets. The existing methods, technologies, and systems for searching time series data sets for multi-dimensional patterns that span multiple related time series data sets suffer from excessive matches, poor performance for large time series data sets (time series data sets with many values), and limited ability to seamlessly overlay additional related information, such as contextual information for making decisions, that is crucial for proper interpretation of query results.

To tractably manage very large time series data sets, existing technologies and approaches may distribute these time series data sets across multiple machines that are linked together for data management. But these existing methods, technologies, and systems do not work seamlessly across widely dispersed, heterogeneous data centers. Furthermore, in a shared data environment where multiple entities contribute data, current methods, technologies, and systems do not provide adequate mechanisms to enable the entities to fully control lifecycles of their data (for example, the data that they own, control, etc.) while concurrently enabling the various entities to generate and utilize shared queries that span all relevant data provided by any of the various entities.

Many existing methods, technologies, and systems enable synopses (approaches for approximate query processing) of large time series data sets via either online stream processing techniques local to a single machine (for example, in memory) or via calculations performed via batch techniques and periodically updated or refreshed. The existing methods, technologies, and systems do not make distributed stream processing of approximate real-time calculations easily accessible via a unified query interface that is replicable across multiple geographical locations.

Existing distributed data processing methods, techniques, and systems promote data locality by pushing computations to data locations and aggregating and synthesizing results from relevant individual locations; however these methods, techniques, and systems are restricted to pushing computations to single data locations, or groups of similar data processing nodes in homogenous systems utilizing identical or similar technologies, and have limited success in performing computations and aggregating and synthesizing results of high throughput, real-time data sets distributed across heterogeneous systems (for example, systems that span diverse hosting provider data center technologies). Furthermore, such methods, techniques, and systems fail to easily handle certain deployment and replication topologies that may be used when disparate data owners elect to pursue multiple and differing data replication and distribution policies.

Finally, all existing methods, technologies, and systems treat time series data sets conceptually as sequences of timestamp and value pairs linked to variable contextual information, and leave considerations of location of the stored data to the underlying implementations, preventing full utilization of this location information for data management. Accordingly, there is a need for new and improved methods, technologies, and systems for providing better real-time management of the storage, replication, retrieval, and synopses for real-time and historical high-frequency time series data.

### SUMMARY OF CERTAIN INVENTIVE ASPECTS

The implementations disclosed herein each have several innovative aspects, no single one of which is solely responsible for the desirable attributes of the invention. Without limiting the scope, as expressed by the claims that follow, the more prominent features will be briefly disclosed here. After considering this discussion, one will understand how the features of the various implementations provide several advantages over current approaches and systems for managing time series data.

One aspect of the subject matter described in the disclosure provides a system for managing a time series data set, the time series data set including a plurality of time series data elements, each time series data element comprising a timestamp, a value, and a context information. The system comprises a time series manager. The time series manager comprises a processor configured to manage a defined time series data set, a memory, and a storage configured to store the defined time series data set. The time series manager is individually identified by a unique identifier, and configured to define a defined time series data set, the defined time series data set including the plurality of time series data elements, each time series data element further comprising the unique identifier. The time series manager is also configured to define an index based on the defined time series data set, wherein the index is used to identify matches of a query within the defined time series data set, and store the index in the time series manager. The time series manager is further configured to define a sketch based on the defined time series data set, wherein the sketch is used to provide results and synopses from the defined time series data set based on the query, store the sketch in the time series manager, query the defined time series data set and associated information, insert, update, or delete a single data element, or a batch of data elements, within the defined time series data set stored in the time series manager, wherein the insert, update, or delete causes the index and sketch to be updated in real-time, and provide a view configured to retrieve and present information from at least one of the defined time series data set, the index, the sketch, the matches, and the results and synopses, wherein the defined time series data set, the index, the sketch, the matches, and the results and synopses are updated in real-time.

Another aspect of the subject matter described in the disclosure provides a method of managing a time series data set using a time series manager identified by a unique identifier and comprising a processor configured to process and store the time series data set, a memory, and a storage configured to store the time series data set, wherein the time series data set includes a plurality of time series data elements stored in the storage, each of the time series data elements comprising a timestamp, a value, a context information, and the unique identifier. The method comprises configuring a definition of the time series data set by the time series manager and storing the defined time series data set in the storage. The method also comprises defining an index, via the time series manager, based on the defined time series data set, wherein the index is used to identify matches of a user query pattern within the defined time series data set, storing the index in the time series manager, defining a sketch based on the defined time series data set, wherein the sketch is used to provide at least one of results and synopses from the defined time series data set based on user queries, and storing the sketch in the time series manager. The method further comprises indexing the defined time series data set using the index stored in the time series manager and sketching the defined time series data set using the sketch stored in the time series manager. The method also includes updating data within the defined time series data set stored in the time series manager, updating the index based on the updating of the data within the defined time series data set, and updating the sketch based on the updating of the data within the defined time series data sets. The method further includes querying the defined time series data set and associated information, and providing a view configured to retrieve and present information from at least one of the time series data set, the index, the sketch, the matches, and the results and synopses.

An additional aspect of the subject matter described in the disclosure provides an apparatus including a computer program product comprising a computer readable medium comprising instructions that, when executed, cause the apparatus to perform a method of managing a time series data set using a time series manager identified by a unique identifier and comprising a processor configured to process and store the time series data set, a memory, and a storage configured to store the time series data set, wherein the time series data set includes a plurality of time series data elements stored in the storage, each of the time series data elements comprising a timestamp, a value, a context information, and the unique identifier. The method comprises configuring a definition of the time series data set by the time series manager and storing the defined time series data set in the storage. The method also comprises defining an index, via the time series manager, based on the defined time series data set, wherein the index is used to identify matches of a user query pattern within the defined time series data set and storing the index in the time series manager. The method further comprises defining a sketch based on the defined time series data set, wherein the sketch is used to provide at least one of results and synopses from the defined time series data set based on user queries and storing the sketch in the time series manager. The method also includes indexing the defined time series data set using the index stored in the time series manager, sketching the defined time series data set using the sketch stored in the time series manager, updating data within the defined time series data set stored in the time series manager, updating the index based on the updating of the data within the defined time series data set, and updating the sketch based on the updating of the data within the defined time series data sets. The method further includes querying the defined time series data set based on at least one of the index and the sketch and providing a view configured to retrieve and present information from at least one of the time series data set, the index, the sketch, the matches, and the results and synopses.

One more aspect of the subject matter described in the disclosure provides an apparatus for a time series data set using a time series manager identified by a unique identifier and comprising a processor configured to process and store the time series data set, a memory, and a storage configured to store the time series data set, wherein the time series data set includes a plurality of time series data elements stored in the storage, each of the time series data elements comprising a timestamp, a value, a context information, and the unique identifier. The apparatus comprises means for configuring a definition of the time series data set and means for storing the defined time series data set in the storage. The apparatus also comprises means for defining an index, based on the defined time series data set, wherein the index is configured to identify matches of a user query pattern within the defined time series data set, means for storing the index in the time series manager, means for defining a sketch based on the defined time series data set, wherein the sketch is used to provide at least one of results and synopses from the defined time series data set based on user queries, and means for storing the sketch in the time series manager. The apparatus further comprises means for indexing the defined time series data set using the index stored in the time series manager and means for sketching the defined time series data set using the sketch stored in the time series manager. The apparatus also includes means for updating data within the defined time series data set stored in the time series manager, means for updating the index based on the means for updating the data within the defined time series data set, and means for updating the sketch based on the means for updating the data within the defined time series data sets. The apparatus further includes means for querying the defined time series data set and associated information and means for providing a view configured to retrieve and present information from at least one of the time series data set, the index, the sketch, the matches, and the results and synopses.

### BRIEF DESCRIPTION OF THE DRAWINGS

FIG. 1 is a block diagram of a system for managing time series data sets, comprising canonical system architecture, in accordance with an example implementation.

FIG. 2 is a screenshot of a screen an interface for interacting with the system of FIG. 1 that details the selection and configuration of a collection of locations that manage time series data, in accordance with an example implementation.

FIG. 3 is a screenshot of another screen of the interface for interacting with the system of FIG. 1 that enables a configuration of time series data sets that may be stored in the system of FIG. 1 and that may be indexed and sketched according to various methods, in accordance with an example implementation.

FIG. 4 is an additional screenshot of another screen of the interface for interacting with the system of FIG. 1 that allows for the configuration and display of data retrieval capabilities of the system of FIG. 1, in accordance with an example implementation.

FIG. 5 is a screenshot of an interface for configuring and displaying sketches and samples using the system of FIG. 1, in accordance with an example implementation.

FIG. 6 depicts multiple frame diagrams consisting of information and/or fields that may be included in various data frame structures and view frame structures of the system of FIG. 1, in accordance with an example implementation.

FIG. 7 is a block diagram illustrating an example of a data management scenario facilitated by a number of time series managers distributed across a pair of data centers.

FIG. 8 is a block diagram that lists the primary memory, storage, and hardware components that enable the functional capabilities of time series managers.

FIG. 9 depicts a flow chart for a method of managing a time series data set, in accordance with an example embodiment.

### DETAILED DESCRIPTION OF CERTAIN ILLUSTRATIVE EMBODIMENTS

Various aspects of the novel systems, apparatuses, and methods are described more fully hereinafter with reference to the accompanying drawings. This disclosure may, however, be embodied in many different forms and should not be construed as limited to any specific structure or function presented throughout this disclosure. Rather, these aspects are provided so that this disclosure may be thorough and complete, and may fully convey the scope of the disclosure to those skilled in the art. Based on the teachings herein one skilled in the art should appreciate that the scope of the disclosure is intended to cover any aspect of the novel systems, apparatuses, and methods disclosed herein, whether implemented independently of, or combined with, any other aspect of the invention. For example, a system may be implemented or a method may be practiced using any number of the aspects set forth herein. In addition, the scope of the invention is intended to cover such a system or method, which is practiced using other structure, functionality, or structure and functionality in addition to or other than the various aspects of the invention set forth herein. It should be understood that any aspect disclosed herein may be embodied by one or more elements of a claim. The detailed description and drawings are merely illustrative of the disclosure rather than limiting, the scope of the disclosure defined by the appended claims and equivalents thereof. Other embodiments may be utilized, and interface, structural, logical, and similar changes may be made to these embodiments.

The present application discloses an embodiment that may enable the novel deployment and configuration of collections of time series managers that store and retrieve volumes of time series data, the time series data being of any type and frequency. The time series managers may uniquely facilitate the rapid retrieval and synopses of the time series data.

Time series data may comprise a sequence of data points, for example multiple successive measurements (a series) made at a given frequency over a period of time. In general, data from a time series data set is usually expressed as a (possibly infinite) sequence of three pieces of information: a data value corresponding to the measurement, observation, or event at an instant of time, a timestamp corresponding to the instant of time that the data value corresponds to, and a context identifier. In some embodiments, the context identifier may include a label that provides a link to relevant information, for example event descriptions, reasons for collecting the time series data, associations with other data (including possibly other time series) that may be used to interpret this time series data, and various other information that may inform the operational, reporting, or strategic intent underlying the collection and analysis of such data. Furthermore, a wide variety of high volume data, while not strictly time series data, is suitable for management by such systems via minor modifications. For instance, multi-media data such as audio and video are expressed in frame rates, which can be converted to numeric high frequency data for storage and analysis. In addition, many industries such as the financial, medical, and geophysical industries generate voluminous data that is sequential in nature, which is mathematically equivalent to time series via simple transformations and context modifications; these may also be managed by systems described herein.

The present application discloses an embodiment that may enable the management, in real-time, of time series data such that rapid storage, retrieval, and approximate query processing scenarios of the time series data distributed across multiple time series managers can be efficiently fulfilled. Additionally, the embodiments disclosed herein may enable such real-time management and manipulation of time series data that is incrementally updated. In some embodiments, a time series manager may embody a logical location in a system for managing and manipulating time series data. The time series manager may comprise a collection of equipment that is capable of storing and manipulating the time series data and data storage where the time series data may be stored. For example, the time series manager may comprise one or more processing nodes, wherein each processing node may include one or more processors and/or computing devices configured to manage (for example, store, replicate, retrieve, archive, backup, etc.) and manipulate (for example, query, summarize, sketch, transform, etc.) and one or more storage locations, for example a memory database or a separate, standalone database. In some embodiments, the time series manager itself may include more than one other time series manager (for example, the time series manager may include a sub-system of equipment, etc., from another related system. The present application describes a system that may work at a level of abstraction higher than a traditional database and may assume that some features provided by a traditional database (for example consistency, transactions, and failover) are also available to implementations described herein without prescribing a specific approach or technology for achieving these. In some embodiments, the time series managers may be associated with both data (for example time series data) processing equipment and memory (for example, memory for storage of time series data and/or associated elements and memory for operation of programmed instructions and commands).

The time series manager (or other similar logical location or abstraction) may allow for the use or application of the system independent of the user's requirements. For example, the time series manager may allow the user to enter details of the desired data configuration and establish or otherwise set up the necessary management needs (for example, logical structure, storage, etc.) based on the user's needs without requiring the user to provide details regarding memory size, etc. Such an embodiment may reduce the potential for user entered mistakes and simplify the establishment, and reduce the maintenance costs, of time series data management.

As the time series manager may be instantiated in multiple structures, for example, as a system of one or more nodes or a system of one or more time series managers comprising one or more nodes, the system described herein may be configured to accommodate heterogeneous hierarchical structures. For example, time series data sets stored in individual nodes in a single data center may be networked or otherwise connected and/or associated with time series data sets replicated across dozens of time series managers in various data centers, thus allowing the aggregation, analysis, manipulation, and management of much larger systems of time series data than previously possible. In particular, the time series manager abstraction enables a single times series manager to use its own logical location to refer or link to a another parallel system of time series managers or even another cluster of unrelated nodes managing time series data, thus enabling vast hierarchies, spanning multiple levels, that link all time series data for shared querying.

In some embodiments, one or more time series managers having the same information stored therein may form a replication set (replica set). One or more replication sets may be deployed in or across one or more data centers. In some embodiments, the time series managers forming the replication set may be exact copies of each other (with regards to the time series data sets stored thereon). In some embodiments, the time series managers forming the replication set may share at least one common time series data set.

In some embodiments, one or more time series managers may be added and deleted from a replication set or a data center with no material impact or consequence to other users and time series managers unrelated to them with regards to the functionality and data available to the other users and time series managers. Furthermore, the data associated with sets of time series managers may be replicated according to any desired replication topology via various configuration options. Additionally, monitoring and management of the required systems and services may be enabled to ensure correct operation of the system.

A time series pattern (or a motif) is defined here as an arrangement of a set of values from any time series, having a specified length or dimension, starting at some specific location within that data set. The length of this set of values, from a single time series data set, is indicative of the chosen dimensionality for analyzing that data set. For example, time series data of dimensionality 4 includes all arrangements of that time series of a length of 4 values. In some embodiments, these arrangements may be consecutive sub-sequences of time series values, while alternate embodiments may vary these as needed. For data retrieval, the choice of dimensionality in a retrieval query may vary across users and their needs, and thus the system may enable multi-dimensional data retrieval for all likely dimensions of interest.

Multi-dimensional time series data retrieval may involve searching for any time series pattern in a time series data set, with dimensionality establishing the pattern length, retrieving relevant sub-sequences of that dimensionality, that are in some sense similar or close to the query pattern. For example, the time series pattern may include a set of twenty values in a given order or arrangement. The multi-dimensional time series data retrieval may comprise a search of the associated time series data set for the time series pattern. Accordingly, results of the multi-dimensional time series data retrieval may include times (or locations) within the time series data set where the indicated set of twenty values in the given order or arrangement may be found. Such multi-dimensional time series data retrieval may be accomplished via a minimization of a normalized similarity measure, for example a Euclidean Norm between candidate patterns (patterns being searched for) and the query pattern. However, scanning each time series data set, over a sliding window of the length (for example, the dimension) of the query to identify the candidate patterns and then re-computing the similarity measure each time, is an incredibly slow and tedious (for example, high resource) process for even reasonably small amounts of data and require complicated, resource intensive approaches to reduce query response times. Some embodiments may utilize an index-based approach to speed up such multi-dimensional data retrieval. Additional embodiments may employ other methods for identifying matches for time series patterns within each time series data set, though not described herein.

Various methodologies may be used to index time series data. Example methodologies may include dimensionality reduction techniques (for example, motif pattern indexing) and locality sensitive hashing techniques. Locality sensitive hashing techniques may enable rapid search and retrieval of known patterns (for example, previously searched or used patterns) or new patterns across time series data sets of any length. Furthermore, provision for ranking results (for example, based on similarity with the time series pattern, etc.) and for limiting searches to a search radius specified in the query is important to consider for implementations.

Summarization of very large time series data sets using previous systems may also provide poor query response times and may require complex, resource intensive solutions to reduce response times and latencies when incrementally updating data and refreshing the summaries. Generating data summaries via synopses may include generating sketches of the time series data sets. A sketch may include a brief summary or compact representation of the time series data set. Generated sketches may have a relatively small and constant size, despite the summarization of ever increasing amounts of data. Generation of sketches, according to some embodiments, may include a unique hybrid approach to incrementally sketching time series data in a time series data set in a single pass and storing incrementally updated versions of the sketches for query processing. However, other methods of generating sketches may be used in conjunction with the novel elements disclosed herein. Thus, when a summary is requested, a stored sketch may be instantly retrieved and utilized to provide detailed descriptive statistics and approximate results for queries of the time series data set. Such sketches may be used to determine a frequency count or proportion of any given query value or value range, a stream value for a given query frequency, and known heavy hitters (most frequently stored values or measurements) in the data. In many embodiments, frequency counts may be important for approximate query and analytical tasks, for example join size estimation or entropy calculations, each of which can also be estimated via sketch based queries. Heavy hitters (the most common elements within a data set, which may be important for many analytical workflows) may be quickly retrieved via separate counters, dedicated for this purpose, during sketching. Heavy hitter detection is a known problem, and difficult to estimate in data sets of large cardinality without employing such sketching techniques. Note, that queries may span sets of time series data, each of which may be separately sketched. Thus, embodiments may compute these summaries and counts globally, or across any arbitrary collection of sketches, by combining them appropriately.

Additionally, alternate embodiments may provide for the limiting of queries to sub-samples of the time series data for rapid approximate responses to complex user queries (for example, sampling methods may be used to identify sub-samples of the time series data, that are relevant to the query, thus eliminating the need to query the entire time series data set to generate useful answers).

One or more embodiments disclosed herein may utilize a collection of time series managers to manage the time series data. Each time series manager may be assigned a logical identifier, referred to, variously and synonymously in this document, accompanying figures, and in some embodiments of the invention as a “logical storage location”, “storage location”, “logical number”, “logical node”, “ln”, or “node number(s)”, or any set of related identifying information. This identifier may be independent of the time series manager physical location, operational state, network address, data center, hosting provider, or any other detail specific to an implementation of the time series manager. The identifier of the time series manager and its integration with the time series data set and elements may provide one novel aspect or fundamental basis of time series data organization and configuration identified within this disclosure. Conceptually, the time series manager identifier augments the three pieces of information included in time series data (often described as a triple of “timestamp”, “value”, and “context,” as described above) with a “quad” or fourth piece of information identifying the time series manager (or logical storage location) as expressed via this unique identifier. The use of this additional piece of information may be used in novel methods and systems described in this disclosure.

In some embodiments, the logical identifier described above may be configured to provide highly controllable and configurable replication. For example, each time series data set on a time series manager having a specific logical identifier may be associated with a specific replica set. Replication of time series managers and time series data sets having the specific logical identifier may be simplified where the replication process may utilize the logical identifier to indicate what time series data sets, etc., are to be replicated across multiple time series managers. Accordingly, a user may replicate all times series data sets associated with a single logical identifier as opposed to individually replicating the time series data sets or individually indicating which time series data sets are to be replicated. One benefit of such simplified replication methods may include simplified interactions with the user, who may no longer be required to track individual locations of time series data sets and/or generate replication requests including numerous time series data set identifiers. Typically, configuration is performed relatively infrequently and by a few users who are entitled to do so (have appropriate permissions), while queries are performed by a large number of users at much greater frequencies. Thus, the vast majority of users can utilize the nearest data center for fast time series data queries without having to consider details such as data replication and configuration, a scenario commonly encountered when data from a large number of remote data collection locations is consolidated within a few data centers such as operational monitoring stations or enterprise headquarters. Queries to local data centers can be many hundreds to thousands of times faster than queries to remote data centers.

Additionally, or alternatively, a user may issue a query to process or aggregate or otherwise manipulate all time series data sets associated with the specific logical identifier (thereby manipulating only time series data sets at a particular logical location) without having to specify or individually indicate individual time series data set names or identifiers. Finally, as discussed earlier, the time series identifier may express a link to an alternate system or parallel cluster of machines, with their own collections of time series data sets in possibly alternate formats and representations that are distinct from the system under consideration, thus enabling networks of such systems to function as a single equivalent system for shared data queries. By using logical identifiers in hierarchical overlay networks, and views, this disclosure facilitates the creation of time series management and query systems with no scaling limits. In some embodiments, the query may be issued by the user or by an enterprise system or any other device, entity, or system. Additionally, the query may comprise one or more queries; for example, queries issued by the user or other entity may include a query for an index, a sample, a sketch, a match, or any other aspect of the system.

In some embodiments, when multiple systems are linked via the overlay network, replica sets may not extend across systems, but rather only across data centers that are part of a single system. However, other embodiments can include replica sets that span across systems. Also, note that the same data center can be part of multiple systems with no limitation. Furthermore, data centers are not restricted to those provided by hosting providers in certain geographical locations and availability zones, but a construct that can be designed, via appropriate networking, in any desired location and configuration with no limitations.

The time series manager identifier as stated is logical in concept and may identify the one or more components (for example, processing nodes and/or storage locations) that constitute a single time series manager. In some embodiments, the storage locations may be used for one or more of storage of time series data sets and processing of commands (for example, operational memory). In an embodiment, each time series manager described above may be assigned a unique identifier that starts at some reference identifier (for example, zero) and is sequentially incremented (for example, the next time series manager may be given the identifier “1”). As time series managers are added and removed from the system, these identifiers may increase, and additionally gaps may develop in the sequence of accessible identifiers, but new time series managers may typically only be assigned the next highest identifier across the extant sequence of identifiers. In some embodiments, identifiers that are not currently assigned but that are not the next highest identifier (for example, an identifier that was previously assigned to a time series manager that has since left the system) may be assigned such that gaps in the sequence are minimized. In addition, as described above, the logical identifier may not be associated or correlated with its geographical location, thus consecutive logical identifiers could be located in different continents or cities, etc. altogether. Other embodiments may vary the manner of assigning a logical identifier or replace the logical identifier with a token or some collection of variable meta-data or tags, but the fundamental notion of a uniquely identifiable and addressable logical location may be utilized by all embodiments of this disclosure.

Note that the use of the word “user” throughout this document and accompanying figures may encompass all potential clients (i.e. all providers and consumers of time series data) of the implemented invention, including human users, automated agents, services, systems, applications, and all other entities that may store and retrieve time series data. In alternate embodiments, ensuring authentication, authorization, and data sharing entitlements for such users may be considered a natural extension of this disclosure.

In some embodiments, such users may create time series managers, with appropriate storage, resource configuration choices, and replication requirements as best suited for their time series data and data lifecycle requirements. Embodiments may provide recommendations, best practices, and relevant sizing information to enable users to make appropriate selections. In some embodiments, the process for creating time series managers and configuring their requirements, etc., may vary and/or be automated as needed to meet specific workflow or data sharing needs and situations. Users may not create schemas, databases, tables, or other entities and attributes as in traditional time series application products. Instead, storage of time series data sets may be enabled via a configured unique (per user) time series data set identifier, the assigned logical node, a storage time period, and the data type and frequency. In some embodiments, different users may use the same identifiers for their data since they may use different logical locations.

In some embodiments, each time series manager may logically store a time series data set in its entirety, regardless of storage volume. In some embodiments, multiple time series data sets may be associated with a single time series manager; however, each such time series data set may be associated entirely with that sole time series manager. Such association may ensure data locality for a given time series data set and all queries associated with that time series data set. Such an arrangement may allow different users to independently own, control, and manage where their data is located and data lifecycle, while still enabling each of the different users to share data queries and retrieval, thereby enabling and facilitating new collaboration and data use scenarios and workflows. Additionally, certain entities may be enabled to comply with local or centralized regulatory requirements, entity specific data retention policies, and other needs requiring a chain of custody for such data, which may not be possible if data location cannot be verifiably enforced.

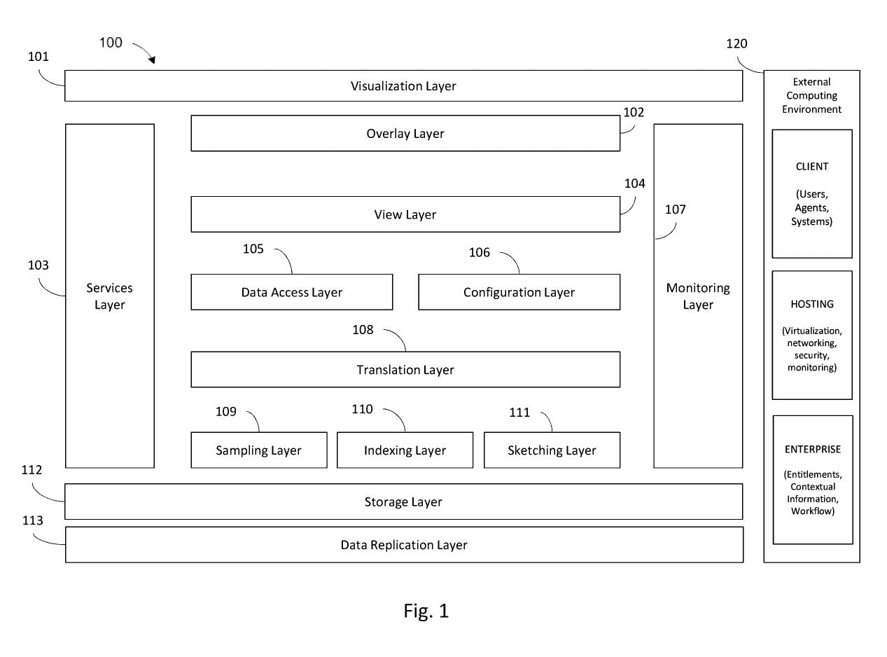

FIG. 1 is a block diagram of a system 100 for managing time series data sets, comprising canonical system architecture, in accordance with an example implementation. In an embodiment, each time series manager described above may be considered conceptually identical to any other time series manager. Thus each time series manager in an implementation may be identical with respect to the components deployed therein (for example, nodes, storage locations, etc.). Alternate embodiments may vary this practice as needed based on a particular implementation with regards to a combination of components to deploy in the time series manager(s). For instance, if multi-dimensional retrieval features are not required for a collection of time series data sets for a specific user, the indexing layer may be omitted from that specific time series manager.

In some embodiments, the various layers depicted in FIG. 1 may be implemented in a single time series manager or in the system 100 comprising multiple time series managers. Each time series manager and/or system 100 may include fewer layers than shown in FIG. 1 or more layers than shown in FIG. 1. Also, FIG. 1 depicts certain aspects of the external environment that distinguish between the capabilities of the time series manager and those derived from the external environment in which the time series managers are deployed and function. Such external capabilities may include a variety of client programs that interact with time series managers that may be initiated by human users, automated agents, or other systems, a variety of hosting environment capabilities such as networking, security, monitoring, and hardware virtualization, and enterprise capabilities such as entitlements, contextual information associated with time series data, and organizational workflow. For purposes of discussion below, a time series manager may be explained to include each of the layers described, though such discussion may refer instead to the system 100 as a whole. By using the layers described below, a user may create and deploy a time series manager, configure the time series manager for storing various time series data sets, and then query the time series manager.

As shown in FIG. 1, each time series manager may include a data storage layer 112. The data storage layer 112 may be tasked with persisting and managing the actual data storage (for example the storage location of the time series data and/or the memory in which the analysis may be performed). In some embodiments, the data storage layer 112 may distribute the time series data across the nodes included in the time series manager for efficient, optimal storage and retrieval, in accordance with database management techniques.

The time series manager may also include a data replication layer 113. The data replication layer may replicate, in real-time, configured time series data across the system 100. The replication configuration that may be implemented by the data replication layer 113 may vary by user, replica set, time series data set, data type, data frequency, or any combination of these or similar factors. This layer primarily interacts with the storage layer to replicate data and with the configuration layer to obtain the needed configuration information.

The time series manager may also include an indexing layer 110. The indexing layer may incrementally, in real-time, update a configured retrieval index or indexes for a given time series data set. For example, as new data for the time series data set(s) is received and stored in the nodes of the time series manager, the indexing layer 110 may update the indexes used to track the retrieval of the data. Indexing may proceed through a sequence of steps—first the prior index may be fetched from the storage layer 112, the new segment of the time series may be hashed by the appropriate locality sensitive hash functions, the computed updates to the inverted index may be saved, and finally the index configuration and hash functions may also be saved for use for upcoming queries or the next update iteration for new data. However, in some embodiments, the method of indexing described above may be replaced by any other known method of indexing.

The time series manager may further include a sketching layer 111. The sketching layer 111 may incrementally, in real-time, update data synopses sketches as new data for the time series data set is received and stored in the system. Sketching, as performed by the sketching layer 111, may proceed by fetching the prior sketch from the storage layer, updating the statistics (for example mean, median, minimum value, maximum value, etc.), updating the sketch frequency counters (for example, the frequency with which a particular value is found in the time series data set, and the frequency of the most commonly encountered values or heavy hitters), and finally saving the sketch for use by upcoming queries or the next update iteration for new data. The sketches, as described above, may have an approximately constant size in memory or persistent storage, such that while the sketches may be updated to provide an accurate representation of the corresponding time series data set (which may be incrementally growing), the size of the sketch itself does not increase substantially. In some embodiments, the sketching layer 111 may be configured to perform sketches across multiple time series managers or load-balanced within the managers comprising any replica set to achieve improved performance and robustness.

The time series manager of FIG. 1 also includes a layer for sampling data 109. The sampling layer 109 may generate sub-samples of a specified time series data set and may execute queries on the sub-samples instead of executing queries on the entire time series data set. Such a method of executing queries may improve response time of queries for a particular time series data set because querying a sub-sample may be more quickly performed than querying the entire time series data set. In some embodiments, sub-sampling may occur “on demand,” where the sub-sampling is performed as part of the query processing itself. However, other embodiments may provide alternative options for sub-sampling to increase performance (for example, pre-computing sub-samples).

The time series manager also includes a translation layer 108. The translation layer 108 may mediate and translate all queries and requests to the core data storage layer. Some embodiments may utilize this layer to manage bulk data uploads and retrievals using known mechanisms for serializing and de-serializing time series data in compact binary formats. This ensures that data management operations can be conducted efficiently for high frequency data at large scale. Other embodiments may use such a layer for type translations or data conversions for complex time series data types such as multi-media and proprietary domain specific data across different industries. Still other embodiments may choose to add data compression capabilities to this layer to enable more compact lossy or lossless storage of time series data.

The time series manager also includes a data access layer 105, which may provide access to the data stored in the memory. For example, the data access layer 105 may comprise one or more mechanisms allowing users or time series managers to upload time series data and time series data sets, and retrieve time series data and time series data sets using means such as, but not restricted to, relational structured query languages, representational state transfers, and other known data exchange and query interface mechanisms.

The time series manager further includes a configuration layer 106. The configuration layer 106 may be designed to enable a unified interface for configuring time series data, indexes, and sketches across various time series managers or user interfaces. This layer may provide an abstraction that insulates a user from data management considerations associated with creating data structures or tables and distributing or sharding data. This layer may enable interfaces to configure time series data sets as well as zero or more indexes and/or sketches. In some embodiments this may occur in a manner that ensures that actions by one user are not impacted by the actions of another user, thus ensuring concurrent shared use of large such systems by numerous participants. Embodiments may typically configure data via this layer prior to subsequent operations such as data storage and retrieval.

In many embodiments, view and overlay layers 104 and 102, respectively, may be enabled via a data virtualization layer (not shown in FIG. 1) that enables the seamless integration of the system time series data sets with enterprise data. Embodiments can utilize data adapters that can be easily deployed in data virtualization platforms to connect to alternate, proprietary systems, a capability that a time series manager can exploit to seamlessly create overlay networks to achieve unlimited scale.

The time series manager view layer 104 provides an abstraction for user queries without any knowledge of the underlying data, storage or distribution details. For instance, the user can issue a query via this layer for a time range of values from a given time series data set. The view layer 104 mediates this request with the data access layer 105, which may query multiple underlying nodes, tables, rows, and columns of information to retrieve this information. The user may remain unaware of such details since the view layer 104 represents a deliberate simplification over those details without direct relevance to the formulation or execution of a user query. Embodiments that build this view layer 104 on the data virtualization layer can ensure that the time series manager may become indistinguishable from any other organizational data source.

The time series manager also includes the overlay layer 102. The overlay layer 102 may route user queries to the correct time series manager(s) for data processing based on knowledge of data locality. This layer may function to maintain knowledge of system wide data distribution of all time series data sets and may control the optimization of queries. Thus, the overlay layer 102 may split and route queries and query parameters to appropriate time series managers from user access points as necessary. In some embodiments, the overlay layer 102 may allow for linking or association of time series data sets with one or more other time series data sets across disparate time series manager collections. For example, the overlay layer 102 may allow for the integrated management of time series data sets stored across different types of data networks including a variety of hierarchical networks, regardless of the underlying technology on which such networks are constructed. Embodiments that build overlays using a data virtualization layer can benefit from the query optimization and translation capabilities therein, to build nested views to accommodate very large node collections. As an illustration, where a million time series managers are required to manage exabytes of data, embodiments may struggle to manage interfaces to manage all the entities within such a single system even with extensive automation. However, 10,000 such systems, each with 100 time series managers, can be easily managed, linked by hierarchical overlay views that are no more than 10 layers deep. Thus, to process a user query for a specific time series data set, the system can quickly navigate such a tree view data structure to route the query efficiently to the exact node, one among a million that contains the sought after time series data set.

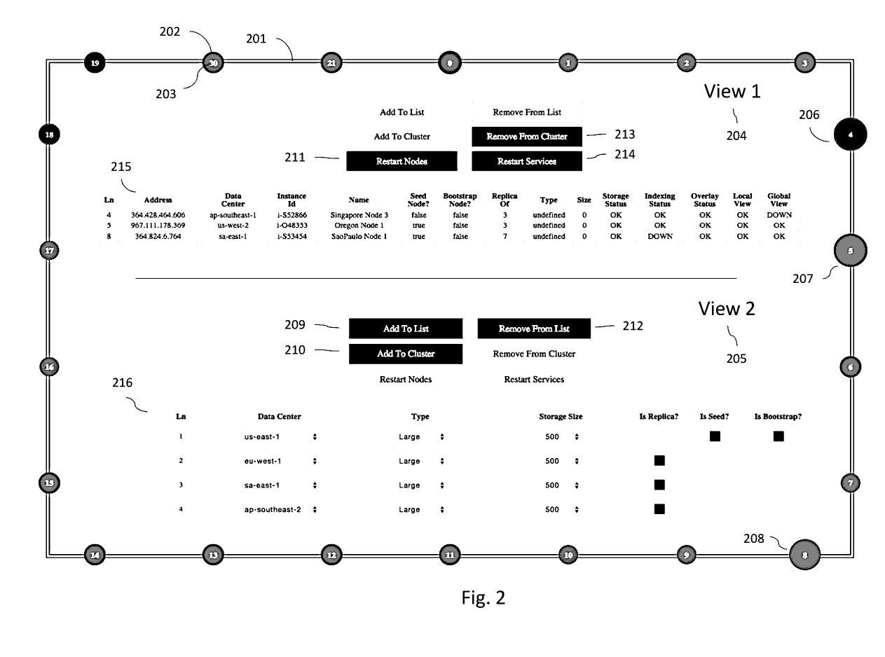

The time series manager comprises a services layer 103. The services layer 103 may be configured to continually monitor and execute any tasks, jobs, or services related to the one or more layers described in relation to FIG. 2. For example, the services layer 103 may include one or more jobs (such as the incremental execution of indexing and sketching calculations) that enable the associated layers (for example, the indexing and sketching layers) to provide the capabilities described earlier. Thus, the services layer 103 may allow the concurrent real-time operation of the collection of time series managers. Jobs and services might also be used for other layers such as a monitoring layer 107 (periodically report status of various time series managers), jobs and services to update the overlay views as the system adjusts to additions and deletions of time series managers, and services to create, launch, restart, or refresh individual time series managers and their nodes.

The time series manager also includes a monitoring layer 107 that may be configured to monitor various status information from time series managers, nodes, storage locations, etc. and provide that information to the visualization layer of requesting time series managers. This information may be used to provide dashboards and alerts for different status representations, for troubleshooting, and for infrastructure management of the equipment and materials associated with any time series manager.

The time series manager may also include a visualization layer 101 that pre-processes or validates user queries and may present a unified configuration, retrieval, management, and verification interface to all users. In some embodiments, the visualization layer 101 may generate the graphics and/or other information rendered for presentation to the user. For example, FIGS. 2 through 5 depict examples of items generated by the visualization layer 101. The visualization layer 101 may be configured to allow the user to link the time series data sets with related contextual information, obtained via the view or data virtualization layers, such that the user may utilize time series data for operational, reporting, or strategic decision-making in a meaningful manner. Embodiments may choose to entirely replace this layer with alternate enterprise investments in visualization platforms, standards, and applications and choose to utilize only the data management capabilities of time series managers with no direct visual interface rendered by the time series managers.

FIG. 1 further shows an external computing environment 120. As shown, this may include a client environment (which may comprise users, agents, or other systems), a hosting environment (which may include virtualization aspects, networking aspects, security aspects, and monitoring aspects), and an enterprise environment (including entitlements, contextual information, and workflow). The external computing environment 120 may comprise the components and/or systems with which the system 100 or time series manager described in FIG. 1 would need to interact. For example, the system and/or the time series manager 100 may interact with client systems (for example a user adding time series data sets to the time series manager or to agents or systems configuring indexes and/or sketches to perform on the time series data sets of the time series manager). Similarly, the system and/or the time series manager 100 may interact with hosting elements that are configured to allow the time series manager to communicate with other systems, users, etc. For example, the hosting element may proving the networking structure and backbone that allows the time series manager 100 to access and be accessed by other systems and devices. Additionally, the enterprise components may include the enterprise controls and structures that may introduce and control policies, etc., associated with the time series manager. The external computing environment 120 may allow the time series manager to function as part of a larger system, integrating the time series manager with devices that may be sources of time series data and with users and systems that use the functionality provided by the time series manager and system 100 to meet their needs.

FIG. 2 is a screenshot of an interface for interacting with the system of FIG. 1 that details the selection and configuration of a collection of time series managers that manage time series data, in accordance with an example implementation. As shown in FIG. 2, various time series managers currently configured in the system can be displayed for user interaction. In some embodiments, the interface may display a subset of the available time series managers or all of the available time series managers. The screenshot visually organizes the displayed time series managers along a rectangular layout 201 bordering the periphery of the interface. The time series managers may be displayed in ascending identifier order in a clockwise direction around the rectangular layout 201 (the example illustrates 22 such time series managers labeled in sequence from 0 to 21). Other embodiments may utilize a variety of visual and automated mechanisms to generate and deliver the interface described here, including other visual layouts with alternate styles and a variety of filters and grouping criteria enabled by user provided meta-data.

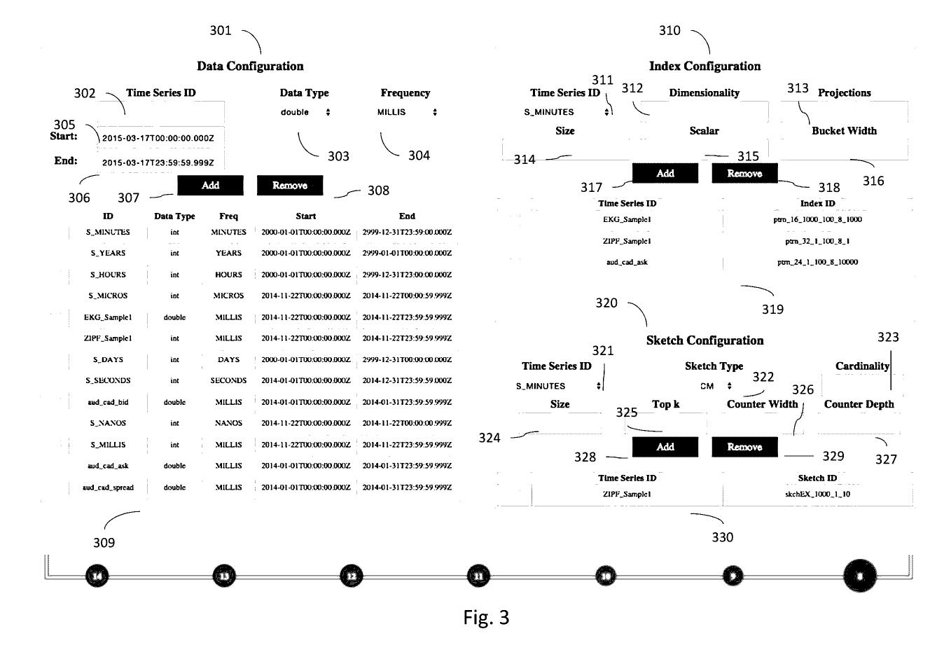

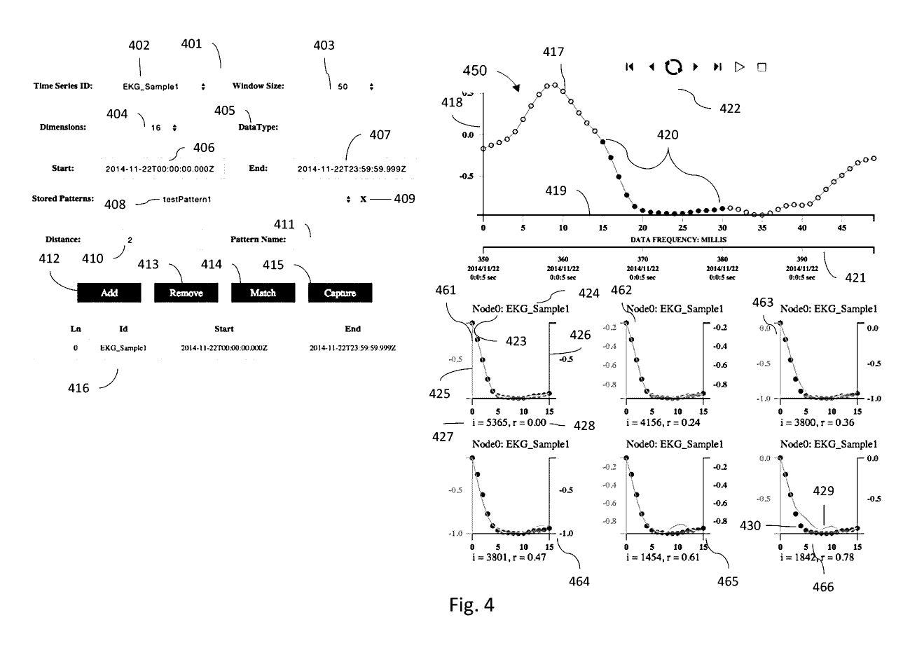

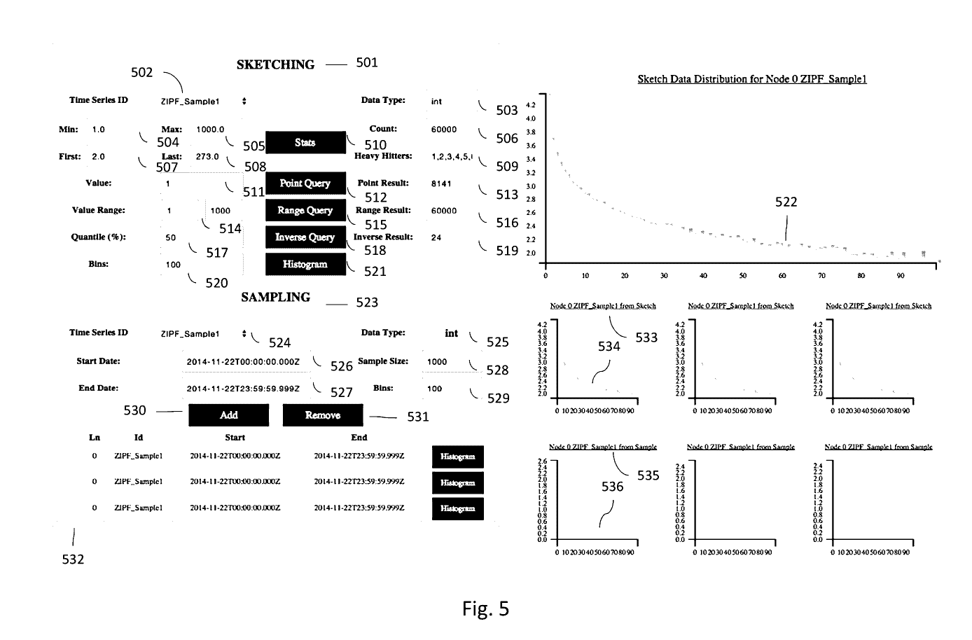

Users may select time series managers from the rectangular layout 201 to enable context and selection specific operations for selected time series managers, including viewing time series manager status, configuring time series data sets (see FIG. 3), and data indexing and synopses (see FIGS. 4 and 5). In an embodiment, time series managers that have been selected by the user from the rectangular layout 201 are visually distinguished from unselected locations, for example by displaying them as being visually larger. For example, time series managers 4, 5, and 8 are shown dramatically larger than the remaining time series managers. Accordingly, time series managers 4, 5, and 8 have been selected, and hence shown in table 215, as described below. The time series managers in the rectangular layout 201 may be part of various hosting providers and/or networks and located at any geographical location. Furthermore, embodiments can choose to use such a visual arrangement of time series managers in all interface views, in a visually similar manner, to ensure uniformity of user experience with time series managers. Thus, it would be useful to assume that a rectangular layout similar or identical to that shown in FIG. 2 is also present in FIGS. 3, 4, and 5. Time series manager selection operations are identical in each interface shown in FIGS. 2 through 5; however, the allowable actions and views vary since each figure details different manager capabilities.

Additionally, or alternatively, the screenshot of the screen of the interface of FIG. 2 may display the time series managers and any associated replicas consecutively along the rectangular layout 201, thus enabling easy and accurate discovery of various replication topologies for multiple time series managers via user selection and inspection operations. For example, time series managers as shown on the rectangular layout 201 that are part of a single replication set may have a particular hashing pattern or shape (not shown in this figure). Since a replica set may extend across multiple data centers, the consecutive managers may be located in very different geographical locations. In other embodiments, which restrict the interface views to a single data center, the time series managers of an entire replica set may not visible at one time.

Additionally, or alternatively, the screenshot of the interface may depict all the time series managers as circles 202 and can color-code the circles 202 to indicate a state of the respective time series manager (“up,” or operational can be shown with a lighter coloring, “down,” or non-operational can be shown with a darker coloring, or partially operational can be shown with no coloring, e.g. 206, 207, 208 etc.). The circle 202 may also include the unique identifier 203 associated with the respective time series manager. Thus, in the example shown, 3 of the 22 nodes listed have been selected (appear larger), and one of these three selected notes are shown as being non-operational (time series manager 4, represented by 206.

In addition, the time series managers that constitute the system may enable the screenshot of the interface, via the visualization layer discussed earlier. In such an embodiment, any of the addresses, which may appear as hyperlinks listed in the table 215, can be utilized to navigate and launch identical views of the interface from any time series manager in the system. In the event, that a given time series manager is abstracting an alternate system, or parallel cluster of machines housing time series data sets, the views may transfer to another system altogether. This process may be greatly eased by incorporating single-sign-on capabilities for time series managers.

The table 215 depicted in View 1 204 of FIG. 2 depicts salient details of the selected time series managers. This tabular view may adjust as different selections of time series managers are made and can appear differently for each interacting user. Such visual arrangements of the locations, and their status and selection operations, are intended to be similar in all interfaces, providing similar functionality across all user operations independent of the time series data or other user location from which the interface is accessed.

Though not shown as such in FIG. 2, in some embodiments only one of either View 1 204 or View 2 205 may be visible on a screen of the user at any given moment in time. In various embodiments, numerous extant tools and providers can be utilized to generate the interfaces, and interact with the underlying hosting providers. For example, other tools and/or software may be used to perform similar launch and configuration processes on associated time series managers without accessing View 1 204 and View 2 205. Examples of the hosting providers may include any means to instantiate a time series manager in a data center. For example, time series managers may be launched in an organization's internal data center or any other hosting environment.

In the screenshot illustrated in FIG. 2, View 1 204 and View 2 205 have six (6) associated actions displayed, three (3) of which are shown as being applied (or available) in View 1 204 and three (3) of which are shown as being applied (or available) in View 2 205. These six (6) actions include: a) Add to List 209, b) Remove from List 212, c) Add to System 210, d) Restart Nodes 211, e) Remove from System 213, and f) Restart Services 214. Add to List 209 may include an action undertaken by the user when the user wishes to configure and add new time series managers for subsequent creation and launch to the table 216 in View 2 205, where the table 216 represents the candidate or proposed collection of new time series managers. Remove from List 210 may comprise an action undertaken to remove or delete a candidate new time series manager from the table 216 of View 2 205 prior to launching the new set of time series managers. Add to System 212 may represent an action undertaken to add new time series managers to the system 100 as finalized in table 216. The status of the action can be checked in Table 215 of View 1 204, which may depict a series of intermediate states before the time series managers are fully deployed and operational (not shown in this figure). In some embodiments, additional fields may be added to Table 215 to indicate these intermediate status conditions or may incorporate the intermediate status conditions within existing fields. In some embodiments, status changes may impact the views generated by the view layer 104 of FIG. 1, and/or the services layer 103 may process requests associated with these status changes and may automatically update the statuses according to the processes and/or requests performed (for example, a deleted time series manager may be removed from the rectangular layout 201 entirely).

The actions shown as available in View 1 204 at selected times series managers include Remove from System 213, which includes an action undertaken to decommission and delete time series managers from the system, Restart Nodes 211, which may comprise an action taken to restart the core storage and view layers or any other layers of FIG. 1 (as referenced above in FIG. 1) in the event of problems as indicated by either or both the status fields in View 1 or the time series managers as visually depicted in the rectangular layout 201, and Restart services 212, which may include an action taken to restart indexing, sketching, and status services, possibly in the event that changes to an index or a sketch configuration has occurred. Other embodiments may automate the detection of such changed configuration information and automatically adjust the processing services.

These actions may be illustrative and other embodiments may utilize similar and/or additional and/or different actions to meet user needs in multiple ways, for instance, actions can be taken that enable data to be archived, copied, or processed prior to termination. Similarly the fields displayed in the tables in Views 1 and 2 204, 205 are illustrative and all variations and combinations thereof are included in this invention.

The table 215 includes an example set of fields, including the following: an Ln field, which may correspond to a Manager Logical Identifier; an Address field, which may correspond to a time series manager server address or addresses (IP Address); a Data Center field, which may correspond to an arbitrary geographic location designation/identifier of the time series manager, typically within a segregated network; an Instance Id field, which may correspond to a unique identifier for the specific physical machine (or node) associated with the manager logical identifier described above. In the event that the identified physical machine is restarted (rebooted), this value and/or the Address field may be assigned a different value, although the time series manager logical identifier and the time series data remain unchanged.

The table 215 also includes a Name field, which may comprise a convenience field for the user to employ and which may be a trivial matter for other embodiments to greatly increase the amount of additional user convenience fields, typically referred to in the field of practice as “tags” or “tagged meta-data”. The table 215 also includes a Seed Node field, which may designate whether the selected node is a seed node (for example, a node that is important for other nodes to determine properties and information regarding other nodes; typically each data center may have one or more of such nodes, which can be omitted or designated mandatory in other embodiments or implementations); a Bootstrap Node field, which may represent the very first time series manager launched in the system. Even though every time series manager may be identical, the first time series manager may be considered special since it bootstraps the rest (for example, in some embodiments the bootstrap node itself enables the first available user interface), so that users can, subsequently from that point forward further augment the system 100 (for example, add more time series managers and their interfaces to the system 100)). Many embodiments may include only one bootstrap node, although alternate embodiments may include multiple bootstrap nodes. Some embodiments may omit or designate mandatory bootstrap nodes. A Replica Of field of the table 215 may represent a time series manager logical identifier to indicate that the time series manager in question is a replica of another time series manager. If this field has the same contents as the contents of the corresponding “Ln” field, then this time series manager is considered as a data time series manager and if the “Replica of field” is different than the “Ln” field, this time series manager is a replica time series manager. The replicas time series manager and the associated data time series manager are usually configured and launched as a replica set, although some embodiments can vary this practice. A Type field of the table 215 may indicate a configurable setting to indicate a level of configured resources for the physical server (e.g. CPU, RAM, etc.), other embodiments may provide many more options depending on the underlying hosting provider and this figure is merely an illustration. A Size field of the table 215 may indicate an amount of user storage desired (e.g. 100 GB or 1 TB). This field may enable users with very different time series data management requirements to launch servers with very different characteristics while still ensuring time series data sets can be shared effectively for queries. The actual allocated storage can be higher than the data size requested depending on the implementation details of the time series manager. For example, additional space for transaction tables, log data, and node operation may be available but not included in this Size field. A Storage Status field may indicate the status of the underlying storage service, while an Indexing Status field may indicate whether the indexing and sketching service is up and running. Overlay Status field may indicate whether the data overlay service is up and running that periodically publishes updates to the overlay view and network, while the Local View field may indicate if the data in the local time series manager is available for querying and a Global View field may, indicate whether data across the system is available for querying via the interface overlay network.

View 2 205 of FIG. 2 depicts a table 216 including a set of fields associated with one or more time series managers that belong to the current system. The fields of table 216, as depicted, include—a Selection field that may be configured to enable users to make changes to selected time series managers prior to undertaking any time series manager specific actions, such as Add to System 210 and Remove From System 213 actions as described above. In some embodiments, the selection of associated time series managers may be enabled by other equivalent or automated mechanisms. The table 216 also includes: an Ln field, which may comprise the next available time series manager logical identifier; a Data Center field, which may indicate the desired data center (for example, the geographical and network grouping of locations) for the new time series manager, a selection of which may be based on the resources needed for the desired time series data set; a Type field, which may be configured to designate a type of machine desired (for example a large machine having extensive resources or a small machine having fewer resources); a Storage Size field, which may be configured to identify the data storage size (for example, the anticipated number of time series data sets to be stored in the time series manager or the amount of storage spaced needed to store the desired time series data sets); an Is Replica field, which may indicate whether selected time series manger is a replica of the data time series manager in the chosen set; an Is Seed field, which may indicate whether this time series manager may serve to seed information to other time series managers in the same or other data centers; and an Is Bootstrap field, which may indicate whether the time series manager is one of the first time series managers to be launched. Some embodiments may elect to designate a bootstrap node as also a seed node automatically without requiring user entry.

In the embodiment shown in FIG. 2, View 2 205 may be used to launch a new time series manager and its replicas as a set. Subsequent time series managers that are configured to an initial time series manager may follow the same replication specifications as the initial time series manager. Furthermore, in some embodiments, one data time series manager and all its replicas time series managers (across all data centers) are launched (or removed) as a unified set (for example, at one time). In some embodiments, the data time series manager and its replica time series managers may not be launched or removed as a unified set, and may vary and add additional options to how they may be launched and removed. In some embodiments, users, who desire additional alternate replication patterns can launch additional time series managers (and any associated replica time series managers) and repeat the process of launching and removing time series managers as many times as needed. Thus, users may have complete control over the lifecycle, distribution, and ownership of their time series data while still enabling shared queries. In extant approaches some users may be uncomfortable with not knowing exactly where their data resides, how many copies of the data exist, and who can view or access the data. Accordingly, the system described herein provides improved mechanisms in to alleviate such concerns. Using the system described herein, users may choose how their data is managed. For example, one user can decide they want to encrypt their data, while other users may decide to keep their data unencrypted. Users can verify that their data may only reside on the time series managers they select, and when those time series managers are destroyed, that no other copies of their data exist anywhere in the system. In some embodiments, any time series manager may be configured (for example, any time series manager may have configurations for time series data sets added to it as in FIG. 3). However, in some embodiments, only time series managers that are part of a data time series manager may be permitted to have configurations of time series data sets added to it because replica time series managers may only be allowed to have information as duplicated from the associated data time series manager and may not need additional configuration options. For example, the time series data set configuration may only need to be performed at one time series managers (for example, the data time series manager) in a replica set.

FIG. 3 is another screenshot of an interface for interacting with the system of FIG. 1 that enables configuration of time series data that may be stored in the system of FIG. 1, data retrieval indexes, and synopses sketches of various types, in accordance with an example implementation. In some embodiments, the functionality, arrangement, layout, parameters, and style may differ from that shown in FIG. 3 dependent on particular needs of organizations. With regards to the information and options shown in FIG. 3, a user may have already selected the relevant time series manager and/or a set of time series managers (as shown on FIG. 2) prior to performing data configuration for the selection according to the options and features shown. In some embodiments, users may perform various selection operations via the interface shown in the screenshot of FIG. 3. The portion of visual layout information at the bottom of FIG. 3, overlaid as an inset representing the rectangular layout described earlier in reference to FIG. 1, shows, as an example, that time series manager with logical number 8 is currently selected, and the entries in Table 309 implicitly refer to the time series data sets currently being managed by this selected time series manager.

Data Configuration item 301 may enable the user to add and remove time series data sets from a list of time series data sets that can be indexed, sketched, and sampled as shown in FIGS. 3-5. The addition of time series data sets to the list 309 may include the user defining a specific time series (defined as a unique combination of the pre-selected time series manager logical identifier and the time series identifier 302). The need and usage of such configuration (with all of its variations across embodiments and implementations) may be considered to be a pre-requisite for initiating the commencement of actual storage and retrieval actions for any time series data. Via the data configuration item 301, the user may add, delete, and/or modify time series data sets associated with the selected time series manager (again for illustration, we include a portion of the rectangular layout 201 of FIG. 2, as an overlaid inset to FIG. 3, that shows the selected time series manager with label 8).

The configuration information for a time series data set required before adding it to the list 309 of configured time series data sets may include the following information: Time Series ID 302, which may comprise an alphanumeric identifier that may be unique across all time series data sets on the particular time series manager and its replicas time series managers; Data Type 303, which may comprise a datatype of the data (for example, numeric, semi-structured, or unstructured, integers, longs, floats, doubles, bits, text, xml, clobs, blobs, multi-media (audio & video files and feeds), other proprietary formats, etc., including any and all possible datatypes for which information may be stored in a database or similar structure or location; Frequency 304, which may include a frequency of the time series data (for example, how many measurements are expected per second or how often the measurement may be made (year, day, second, millisecond, etc.). FIG. 3 examples show values ranging from nanoseconds to years, although other embodiments may show additional combinations and approaches to specify the data frequency; Start Date 305, which may represent the start time (including date and time) for which storage may be configured, such that data in the time series manager having a value of a timestamp prior to the start time may not be stored in the configured time series data set (some embodiments can obtain this information differently (for example via automated system mediated pathways) or may be formatted in a specific manner, for example date and then time in millisecond resolution; and End Date 306, which may correspond to the end time for which storage may be configured, where data having a value of the timestamp past this time may not be stored in the configured time series data set (in some embodiments, this information may be obtained by automated methods). In some embodiments, the end date 306 may be in the future, thus allowing the system to incrementally update the time series data sets indicated in list 309 (for example, add time series data elements to existing time series data sets) up to and including the end time. In some embodiments the timestamp format and the timestamp values themselves are provided by the user when time series data is uploaded or stored (via automated pathways and interfaces not shown in FIG. 3), while in other embodiments the system itself can generate this timestamp based on the data upload or save action. In yet other embodiments, this configuration information may be uploaded or updated along with the actual time series data for storage, thus automating the entire configuration process.

The Add button 307 may correspond to a function that may add the desired user entered configuration information values to the system configuration for that time series manager (thus adding it to the list 309), while the Remove button 308 may delete a selected configuration. In some embodiments, the storage interval can be incrementally updated (increased or decreased) after the first or initial configuration. In some embodiments, the time series data sets shown in list 309 may include gaps or multiple sets of series of time series elements in a single time series data set (for example, a time series data set may include times from 1 second to 10 seconds and also from 15 seconds to 25 seconds). As shown in the list 309, the values that the user entered or selected for the configuration information described above are shown. The list 309 provides columns for a selection block (indicating when a particular time series data set is selected), the Time Series ID (ID) column, the Data Type column, the Frequency column, the start time column, and the end time column. In some embodiments, each of these columns may be sorted (for example may sort by the Frequency column such that time series data sets with greater/lower frequencies sorted at the top of the list, etc.). Other embodiments may employ paging, filters, groups, and/or other mechanisms to manage large sets of time series data to ensure a good user experience.

The index configuration section 310 of FIG. 3 illustrates an example approach to configure indexes for data retrieval, based on known locality sensitive indexing approaches, while other embodiments may vary these to fit an alternate indexing mechanism if chosen. The index configuration section 310 includes fields as illustrated—a Time series identifier 311, which may allow the user to select a time series data set from the previously configured data sets that are shown in list 309 (as described above, configured via the data configuration section 301 for the pre-selected time series manager); a Dimensionality 312, which may comprise the length or number of time series data elements that is to be a query basis for multi-dimensional data retrieval; projections 313, which may indicate a number of redundant ways to index the time series data set to improve the accuracy of the retrieval mechanism (this number represents a trade-off in indexing efficiency, large values lead to increasingly accurate retrievals at the cost of larger index storage sizes, costs, and times); a Size 314, which may represent a size of the configured index itself, the size indicative of a number of unique hash functions employed in sequence to calculate the actual index value corresponding to a data value; Scalar 315, which may represent a multiplier that may be used to scale the time series data of the time series data set and/or to limit the data cardinality to user defined ranges; and Bucket Width 316, which may indicate a setting to spread the data values into “bins” or “buckets” whose values range from 1 to the expected data cardinality. The Add and Remove buttons, 317 and 318, respectively, may indicate actions available to add configured indexes to the list 319 or delete elected indexes from the list 319 for the selected time series managers. In some embodiments, the list 319 may provide a column for selecting a time series data index configuration, a time series ID column, and an Index ID column, where the index ID column may represent a unique identifier (comprising any logical or desired information) for the index configured using the index configuration 310 (which may be automatically or manually generated).

Multi-dimensional data retrieval may provide new workflows and/or opportunities for users to perform additional functions using existing time series data. For example, the system described herein may be configured to perform comparisons between multiple time series data sets of multi-dimensional patterns as selected by the user. This may allow the user to examine and infer relationships among large sets of diverse time series data. In some embodiments, the system described herein may identify more than one type of pattern, each selected from one or more time series data sets, and compare such composite events with similar events that occur at the same time, or in a similar manner at other times, in other time series data sets.

Various methods and techniques may be used to create indexes. For example, known methods may include motif based pattern recognition and locality sensitive indexing using probabilistic hashing techniques to create the index entries. Numerous alternate variations can be utilized in various embodiments. In some embodiments, as illustrated in FIG. 3 (section 310), locality sensitive hashing techniques may be employed and the interface fields listed may correspond to configuring such indexes. This may generate numerous advantages in retrieval efficiency (for example, excessive matches can be reduced) and speed (for example, constant time retrieval regardless of the size of the time series queried) at the cost of index sizes that may be many times larger than the original time series data set. This, additional and expected, burden of index storage may be accounted for and managed in the various embodiments during time series manager creation and time series manager data configuration actions. Furthermore, the chosen hash functions as selected in the index configuration 310 may be the same not only for indexing an entire time series data set but also for indexing a desired query pattern to ensure correct retrieval, and this invention ensures this occurs via the novel incremental indexing method employed.

FIG. 3 also illustrates a sketch configuration section 320, based on known standard sketching approaches, which may allow a user to configure one or more sketches for data synopses, while alternate embodiments may modify these to suit the exact sketching algorithm or approach chosen. The fields that may be involved in configuration of the one or more sketches, as illustrated, include: a Time series identifier 321, which may provide for the selection of the previously configured Time Series ID (discussed above as being configured via the data configuration section 301 for the selected time series manager); a Sketch Type 322, which may provide a mechanism for indicating a type of sketch to be generated from the selected time series data set (for example, a Count Min sketch, etc., where most embodiments may include provide for a wide selection of types of sketches); Cardinality 323, which may represent a measure of a size of the number of expected unique elements of the time series data set; Size 324, which may indicate a measure of a scalar size needed to optionally adjust the cardinality of the set of sketched values (entering the value 1 may indicate no scaling of the data is necessary); Topk 325, which may comprise a numerical value indicating how many of the top heavy-hitters are to be tracked by the sketch, a heavy-hitter being a frequently observed item; Counter Width 326, which may include a setting to control a number of counters tracked by the sketch; and Counter Depth 327, which may include another setting to control the number of counters tracked by the sketch. The Add and Remove buttons 328 and 329, respectively, may represent actions to add configured sketches to the list 330 and delete selected sketches from the list 330 for the selected time series managers, where the list 330 shows the currently configured sketches for the selected time series manager(s).

As described above, the indexing and sketching described above enable query data retrieval within a short retrieval interval, regardless of the size of the time series data set associated with the index and/or sketch. This allows the time series data to scale to any size and to provide similar performance regardless of the size of the time series data set and across all associated time series manager(s). Furthermore, indexing and sketching tasks may be load-balanced to associated time series managers and/or other associated time series nodes that may be replicas (or part of a replica set). For example, if a time series manager includes three replicas, since each of the replicas contain the same data as the initial time series manager, any processing or query tasks the initial time series manager performs on time series data of the time series manager may be shared (or load-balanced) across the remaining time series managers of the replica set. Thus, time series managers may load-balance tasks such that no one time series manager is assigned excessive work while one or more other time series managers perform little or no work.

Robust and efficient indexing of a given time series data set may be difficult to accomplish, particularly when a large time series data set is incrementally updated, when data elements in the time series data set appear out of order, or if the time series data set has gaps that are filled at a later point in time. Poorly constructed indexes may require a complete rebuilding of the index, a very resource and time intensive process that may prevent the system from fulfilling multi-dimensional data retrieval effectively and efficiently. The indexing approach recommended in one embodiment is specifically designed to avoid all these problems. Such embodiments may utilize an indexing approach that is, by design, idempotent and uniquely associates a computed index value with the indexed pattern sequence and its timestamped starting position in the time series data set. Idempotency is defined as having the same result even when some change or process is applied or performed multiple times. In a situation where idempotency applies, even though no changes are needed to any index, if the same pattern of data values is re-processed or re-indexed any number of times, there is no harm done since the index is simply updated with the same value as the prior stored value. This is because the hash functions are unique to a single time series data set; hence the same index value is re-computed as long as the pattern itself remains the same.

In one embodiment, when new data is entered corresponding to the time series data set being indexed, or if a specific data value is updated in the time series data set being indexed, only a small section of the overall time series data set that is immediately adjacent to the updated value needs to be re-indexed and not the entire index of the entire time series data set. For instance, if a time series data set has a length of 1000 and the indexing dimension is 10, then the initial indexing process may take each sub-sequence of length 10 in the time series data set, create a unique index value, and associate that unique index value with a starting position of the sub-sequence. Thus, in this case, the first index calculation may index the data values corresponding to index positions 1 through 10 and then associate that calculated value with index position 1. A total of 991 such indexes can be calculated from 1000 time series data values, values 992 through 1000 cannot be indexed yet since the available sequence would be less than the dimension length of 10. Subsequently, in a situation where the very first data value is updated, only one index value corresponding to index position 1 would need to be recomputed and not the entire index since the other data values are unchanged. Thus, in some embodiments, for any data value update, only the indexes, up to a maximum count equal to the length of the dimension and not the entire data set, may need to be updated, a key to the efficient incremental maintenance of these indexes. At most 10 index values in this illustration would need to be recomputed, for a data value update, rather than 1000 updates, a difference that is dramatically large for time series data sets with billions or trillions of data values. Note that in this illustration, if subsequent data values past index location 1000 are received, the previously unfilled index positions 992 and 1000 may now be filled incrementally.

In some embodiments, it may not be essential to delete an unused or spurious index value based on old data, since all matches are filtered by a distance calculation that uses the most current values to check matches. In some embodiments, a spurious, stale, or redundant index value that participates in the indexed retrieval process causes no harm since this index location merely serves as a pointer to the extant time series sequence that is a candidate match for retrieval. That candidate data sequence may be added to the relatively small pool of candidates and distance matching may be employed to rank the best matches prior to completing the retrieval query, thus filtering out all sub-optimal candidates including potentially the spuriously retrieved candidate if warranted. Other embodiments can vary the exact mechanisms of such incremental maintenance.

Sketches also require careful consideration for incremental changes when new data is received for a time series data set or data in the time series data set is updated. Sketches are not idempotent since they track frequencies, where counts may become incorrect if the same time stamped value is sketched multiple times and the incremental updates may account for such cases. For updated data, sketches can adopt the well known turnstile data streaming approach whereby counters are decremented when deletions occur and incremented when inserts occur. Thus, some embodiments can treat an update as a delete of an existing data followed by an insert of the updated data, even if they comprise the same value. Other embodiments may choose to drop and recreate the entire sketch, this may be more feasible up to some reasonable data set size since sketching is much more resource efficient as compared to indexing.

Various methods and techniques may be used to create sketches as configured above. For example, in some embodiments, a Count Min or an AMS sketch (named after the first initials of the last names of the algorithm inventors Alon, Matias, and Szegedy) may be used for time series data having a large cardinality, or an exact counting sketch may be used for data having a small cardinality (in which case the calculated frequency distributions are exact and not approximations). Various embodiments may use any number of methods and techniques to create sketches as determined by the time series data involved. In some embodiments, the corresponding configuration fields and interface layout as described above may vary based on the methods and/or techniques for creating sketches (for example, based on the information necessary for a particular method and/or technique of creating sketches.

Thus, as described above, in one embodiment a user may first select a particular time series manager and configure the time series data sets that may be associated with the selected time series manager. The time series data sets associated with the selected time series manager may be shown in list 309. Then the user may configure one or more indexes using index configure 310, wherein the time series data sets of list 309 may be selected at time series ID 311 of the index configuration. Configured indexes may be shown in list 319. Similarly, the user may configure one or more sketches using sketch configuration 320, wherein the time series data sets of list 309 may be selected at time series ID 321 of the sketch configuration. Configured sketches may be shown in list 330.

As shown in FIG. 3, the configuration options shown may apply to a single time series manager as selected from the rectangular layout 201 shown in FIG. 2. This rectangular layout 201 exists for each of the screenshots of FIGS. 3-5, though not shown. Accordingly, the user may select a particular time series manager of choice and access the screen shown in FIG. 3. FIG. 3 may allow the user to configure one or more time series data sets that are added or already exist on the selected time series manager. Once a time series data set configuration is added to the particular time series manager, indexing and sketching may be optionally configured for the time series data set(s) that exist for the selected time series manager. Further, as may be described below with relation to FIG. 4, patterns may be shown and/or searched for the indexes configured in FIG. 3, while sampling and sketch analysis for the sketches configured in FIG. 3 may be shown in FIG. 5. Various embodiments may ensure that such data retrieval occurs in real-time, for example as data is continuously added to the system and concurrently indexed and sketched, these updated indexes and sketches may immediately be made available for up to date queries.

Various other embodiments may include additional or fewer components in the data configuration 301, the index configuration 310, and sketch configuration 320. Accordingly, the depiction of the specific fields and options shown in FIG. 3 should be viewed as examples and not limiting.

FIG. 4 is an additional screenshot of an interface for interacting with the system of FIG. 1 that allows for the visualization of time series data and demonstrates the multi-dimensional retrieval capabilities of the system of FIG. 1, in accordance with an example implementation. In some embodiments, searches and/or searching for specific time series patterns may be enabled by a search panel 401 as shown in the screenshot of the interface of FIG. 4. In some other embodiments, alternate mechanisms and/or searching configurations, including automated pathways, may be used. Once the user selects a time series manager of interest, the configured time series for that time series manager (as described above in relation to FIG. 2) may be made available for user selection via time series ID selection 402. As shown in FIG. 4, the visualization control options presented to the user may include a specific window size 403. The window size 403 may indicate a total number of data points in the display window from which a search pattern or sample may be selected, and dimensionality 404, which may indicate a length of the queried pattern. These parameters may be selectable while the datatype 405 of the selected time series is displayed based on the configuration information. In addition, starting (406) and ending (407) times (including dates and times) may be provided to restrict the retrieved results to a specific time range of interest. Additionally, a known pattern of interest may be stored using the pattern name field 411 whenever the user identifies a pattern, believed to be worth persisting, for subsequent recall and use. The user enters a pattern name into field 411 and then actuates the capture button 415 to store or save this new pattern. In some embodiments, the pattern name entered in pattern name field 411 may be unique from other saved patterns names already saved and/or captured.

Any previously stored pattern(s) of interest to users may be displayed for selection by the user via stored pattern field 408, which allows the user to select and load configuration elements of patterns stored in the stored pattern field 408 without individually re-entering the configuration details manually. In some embodiments, the stored patterns may be available for use by all users of the time series manager, although some embodiments may utilize varying entitlement mechanisms, where specific users may have access to specific stored patterns or sets of such stored patterns. Alternate embodiments may provide alternate grouping and filtering mechanisms for such patterns, as well as mechanisms to create composite patterns, a set of patterns each specific to a set of time series data sets, that are collectively matched and retrieved from other candidate sets of time series. Some embodiments may elect to match such composite patterns at the same instant of time or within a tolerance window of times such that each time series for a retrieved composite match concurrently occurred at some point in time within such interval. The delete selector 409 may represent a button that the user may actuate to delete or clear a selected stored pattern from the stored pattern field 408. In some embodiments, this may not actually delete the value in the underlying storage, but merely remove it from the current interface view, so that the next pattern for matching can be selected dynamically from the displayed graphs by interactive user selection operations. The distance field 410 may represent, in normalized space, a maximum distance between the retrieved pattern and the pattern of interest (various embodiments may employ different similarity measures, such as for example an Euclidean measure, to compute such distances), and represents a user provided query parameter (meaning the search may be limited within the parameter value as entered by the user). The larger the value in the distance field 410, the more approximate the matches shown may be to the pattern of interest.

In some embodiments, the Add and Remove buttons 412 and 413, respectively, may correspond to actions available to build a selection list 416 of candidate time series data sets from which data needs to be retrieved, or to delete one or more selected time series data sets from the selection list 416. The selection list 416 may comprise multiple columns representing information fields of the time series data sets from which data needs to be retrieved, for example a selection indicator column, which may indicate if a time series data set is selected from the selection list 416, an Ln column, which may indicate the time series manager logical identifier, the Time Series ID column, the start time column, and the end time column. In one embodiment, these search start and end times do not have to coincide with the data set configuration start and end time, but may represent any desired search interval that is a subset of the configured storage interval. The match button 414 may be configured to retrieve the closest match or matches to the requested pattern from the list of selected time series, as displayed in the selection list 416, and the match parameters entered by the user prior to invoking this action.

An example visualization of a time series specified in the search panel 401 is shown in FIG. 4 as line 417 of graph 450. The x-axis 419 and y-axis 418 of graph 450 are also illustrated. An alternate axis 421 is also shown to provide a scale for the retrieved data in time units that is specific and customized to the data frequency, for example, for high frequency data. In some embodiments, a candidate pattern 420 can be selected, for exploratory matching, by interactively clicking on one or more elements of the line 417. In one embodiment each such user selection operation results in the highlighting of a sequence of values starting at the selected location, as shown in FIG. 4 where the selection 420 is shown in a much darker shade than the unselected portion of the time series data set 417. In some embodiments, beginning and ending time values may be entered, manually or via automated pathway, for the candidate pattern (not shown in this figure). Matches retrieved according to such dynamic pattern selections in real-time is a key aspect of the novelty of this invention. In an embodiment, the user may, in real-time, dynamically select a pattern on the displayed graph and then click the match button, which may then display the results (results being sequences of time series values that match the pattern of interest (or are similar to the pattern of interest). In other embodiments, this selection process may be automated and included as part of enterprise operational, reporting, or strategic workflows.

In some embodiments, visualization and animation controls 422 may be provided. These controls may include the ability to: Scroll Start, to move the visualization window to the start of the search selection, for example, the scroll moves to the earliest available data within the specified start and end time range; Scroll Left, which scrolls the window to an earlier window per the window size 403 translated to equivalent time units; Refresh Window, which may refresh the current view; Scroll Right, which may scroll the window to a later window per the window size 403 translated to equivalent time units; Scroll End, which may move the visualization window to the end of the search selection, for example moving the window to the last available data within the specified start and end time ranges; Animation start, which may, start animating the time series via a sliding window; and Animation end, which may stop any animations in progress. In some embodiments, various other visualization and/or animation processes and methods may be used, including, but not limited to multiple windows, tumbling windows, constant time interval windows, etc. in a wide variety of charting and display configurations.

In some embodiments, when the match button 414 is actuated, rapid retrieval may be enabled based on the real-time indexes if so configured. For example, 6 matches are shown as being retrieved for the candidate pattern 420 illustrated. In some embodiments, for each match retrieved, the time series manager logical number 423 and the user time series identifier 424 (based on the Time Series ID 402) are provided as context in the illustrated match. In some other embodiments, other relevant contextual and other relevant enterprise data may be provided. The time location of the match in the time series data set may be indicated by the index 427, which may be in a scaled format in reference to the data scale of the time series data set, while the exact distance from the candidate pattern 420 may be indicated by r 428. For example, the index 427 may represent the location in the time series data set where the indicated match is located (for example, in relation to the start of the time series data index) while the r 428 of each smaller graph shown in FIG. 4 (graphs 461-466) may represent the distance (in some embodiments the Euclidean distance similarity measure) of that matched time series data elements in relation to the pattern of interest 420 selected above. The distance calculation is always calculated in normalized space while the displayed graphs 461-466 can exhibit axes in either normalized scale or the raw data scale. In one embodiment the left axis 425 of a display may scale the retrieved match while the right axis 426 may scale the pattern. In some embodiments, the left axis 425 and the right axis 426 can be different in magnitude and type.

In some embodiments, the first match (graph 461) in the illustration may be an exact match (a distance of 0 from the query) of the candidate pattern 420, which may be an expected result whenever the candidate pattern 420 originates from a time series data set that is also part of the search selection. In some embodiments, the matching process is, by design, robust to missing data and may scan for a pattern even across gaps, while some embodiments may not be configured to scan across gaps in the time series data sets. In other embodiments the data may be interpolated to fill such gaps, prior to indexing or just for data display, and users may observe a match even in results with gaps in the displayed data. In still other embodiments, data may be compressed, prior to indexing or just for data display, to reduce the size of storage while still enabling approximate matches.

As shown in FIG. 4, once the user has configured the indexes shown in list 319, the user may perform searching of and/or display the time series data of the indexed data sets. FIG. 4 may allow the user to configure one or more searches of indexed time series data sets and/or display and/or monitor these time series data sets in real-time. In one embodiment, as real-time time series data is received and incrementally indexed, animations to the matches may continuously update and present closest matches for a desired pattern, with the matches improving over time as more and more data is indexed and made available for searching. In many embodiments the entire match and retrieval process may occur in an automated manner without the need for any visual interface utilizing the various views and data layers of the time series managers. In yet other embodiments, the indexing parameters can be varied, in an automated manner, for large sets of parameter choices selected at random or from known statistical distributions, to arrive at optimal parameter selections for indexing a particular type of data. Such approaches may provide guidance as to the optimal manner to index specific types of time series data. Still other embodiments may automate this and automatically select the most optimal index for a given time series data set. Various other embodiments of the system 100 may include additional or fewer components in the searching configuration 401 and the pattern display in the graph 450 and the matching graphs 461-466 shown. Accordingly, the depiction of the specific fields and options shown in FIG. 4 should be viewed as an example and not limiting.

In some embodiments, a sample is simply a subset of the original data. When working with a sample, the original query is executed identically as if working with the time series data set except that instead of considering all the possible data elements within the time series data set, only the sample (the subset of time series data elements) is considered to process the query. Accordingly, in some embodiments, sampling is used to provide an approximate answer to the original query, whether the query requested is a summary of the time series data or the actual time series data. Summarization using a sketch may not involve sampling whereas summarization within a sql query (e.g., asking for an average of a time series) is relevant to sampled data. For example, if a time series data set contains 1 million elements, then asking for the sql average may involve reading a million values and computing their average. If an approximate answer is requested with a 1% sampling parameter, then 10,000 values may be read and the average may be computed on that basis, thus providing an approximate answer much faster than the exact query. Alternately, some embodiments may request summary information directly from the sketch. Such a request may not involve reading either the million values or the sampled 10,000 values, but instead simply querying the stored sketch and providing the approximate answer quickly.

FIG. 5 is a screenshot of an interface for configuring and displaying results of sample queries involving sketches and samples using the system of FIG. 1, in accordance with an example implementation. In some embodiments, both sketching and sampling may be provided, while other embodiments can present a large number of related variations. In some embodiments, the sketching section 501 provides for the selection of a time series 502 (corresponding to the Time series generated in FIG. 3) once the user has determined a time series manager of interest. A Data Type field 503 may indicate the corresponding datatype for the identified/selected time series data set. In some embodiments, a Stats button 510 uses the latest, incrementally updated sketch to retrieve the displayed statistics: min statistic 504, which corresponds to the minimum y-axis value for the specified time series data set; max statistic 505, which corresponds to the maximum y-axis value for the specified time series data set; count statistic 506, which corresponds to the total number of data elements stored in the time series data set (this value may increase as more data is added to the time series data set); first statistic 507, which corresponds to the first data element sketched; last statistic 508, which corresponds to the last data element sketched, and the top heavy hitters statistics 509, which corresponds to the values that are encountered most frequently within the time series data set. Some other embodiments can vary the list of statistics provided and may augment the sample list shown by a much wider variety of standard statistical summary information such as, but not limited to, standard deviations and variances, moments of higher order, skew, kurtosis, Gini coefficient, entropy, range, covariance matrix etc. In some embodiments, data values in a single time series data set may be so large (billions or trillions of values) that the data may need to be distributed across multiple tables or rows (it may still be associated with a single time series manager, despite the large set of values). Hence in some embodiments, multiple sketches, each corresponding to different rows, may need to be configured, and the user queries may require information be obtained and aggregated from all relevant sketches. In a similar manner, multiple indexes may also need to be created and queried for pattern matching across very large time series data sets, and the match retrieval for such embodiments may aggregate and present the closest matches across all relevant indexes. Some embodiments may calculate the entropy (or information content).

In some embodiments, a point query button 512 may, when actuated, gives the frequency (Point Result 513) equal to the number of times that the value that user enters as a query parameter in input user query value 511, has appeared in the sketched time series data set. Range queries are queries to indicate how many sketched values are found between the start and end of the range (Range Result, 516) for a user query range (Value1 (start) and Value2 (end), 514) and are enabled by the Range Query action 515. An inverse query 518 action determines the value, as a range or decile, (Inverse Result, 519) for the requested frequency 517. For instance, entering a value of 50 representing the 50th percentile would obtain the median as computed by the sketch. Finally, a histogram button 521 may present a visualization 522 based on the user specified bins 520 (which represent the count of intervals employed to calculate frequencies for display purposes only). Other embodiments can utilize such retrieved information for a wide variety of approximate query processing needs of specific interest to users, particularly in automated pathways employing the data and view layers of time series managers.

As an example of the sampling panel 523, the depicted screenshot of the interface may enable a comparison between sketched and sub-sampled results. The sampling selection may allow the sampling of a selected time series data series based on the selected time series name 524, a data range including a start time 526 and an end time 527, and a datatype 525 of the selected time series data set. The user, via interface entry fields, may specify the requested sample size 528, and the bin counts 529. In one embodiment, the start and end times can be any subset of the configured storage interval for the time series data set, while other embodiments can vary this practice. In an embodiment, the user may compare sampled data distributions with sketched data distributions. The sample size may comprise many data samples to create the frequency distribution. In some embodiment, a large number of such related analysis and charts might be shown for comparison, evaluation, or exploration.

In some embodiments, table 532 displays selections added by the user by utilizing the Add button 530 based on the configuration information entered into the sampling panel 523 and removes selected time series data sets when the Remove button 531 is actuated. By invoking the individual histogram actions via the histogram buttons in the table 532 for respective time series data sets, a user may compare the frequency distribution of the selection 534 as retrieved from the sketch 533 with the distribution of the selection 536 retrieved from a sub-sample 535. In some embodiments, this sub-sampling capability may be utilized to render rapid responses to certain complex user queries without having to pre-generate and save samples for such use. Some other embodiments may also utilize other data sampling mechanisms including some that parameterize the sub-sampling based on meta-data attributes associated with the time series data set. In some embodiments, random sampling without replacement may be used to generate the histograms and samples described above, ensuring that each sampled value occurs no more than once as in the original data stream. In an embodiment, the user may elect to automate such comparisons for a large number of sampling methods to recommend the optimal sampling method for a given type of time series data. This can serve as the basis of a best practice or recommendation and can be automated so that approximate user queries automatically employ the optimal sampling method for that type of time series data set. In another embodiment entropy based distance measures may be utilized to compare such sketched and sampled distributions to quantify the similarity between the distributions.

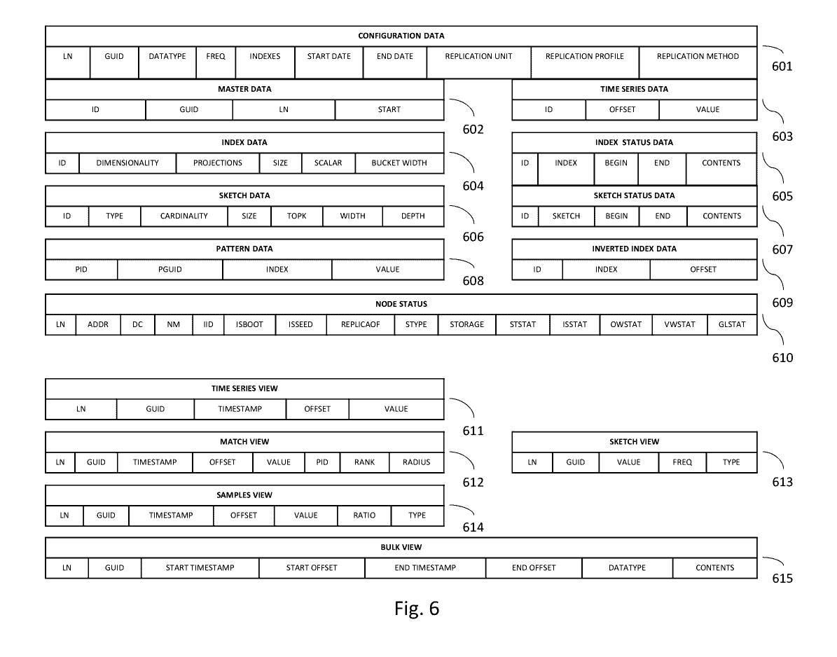

FIG. 6 presents a sample logical data model to illustrate an example embodiment. Other embodiments may vary, rename, add to and customize these core elements to create the actual storage and view data models. The data blocks shown in FIG. 6 may include the data associated with a given function, view, or layer, as described above.

The Configuration Data Entity 601 may represent the data associated with the data configuration field 301 of FIG. 3 and replication data. For example, the configuration data entity 601 data block may include fields for logical number (LN), name of the time series (GUID), the type of the time series (DATATYPE), the frequency (FREQ), the configured indexes and sketches (INDEXES), the starting date for the configuration (START DATE), the ending date for the configuration (END DATE), each of which may be used by the data configuration item 301 of FIG. 3. Additionally, the configuration data entity 601 may further include the unit or table space associated with replication (REPLICATION UNIT), all nodes that are replicas of the current logical node (REPLICATION PROFILE), and the method employed for replication (REPLICATION METHOD). Such information may be used to provide potential options to further configure replication of time series data by implementations. The configuration layer of a time series manager may read and write data values associated with this entity

The Master Data Entity 602 may include fields such as an internal data distribution key identifier (ID), the corresponding logical number (LN,) and name (GUID) and a starting timestamp (START). In some embodiments, these master data records and fields may be created automatically based on the information contained in the corresponding related configuration data entities, other embodiments may vary this practice. This linkage across the Master Data and the Configuration Data entities may be achieved by using the logical number and the name field together as a composite key to relate these two entities. In particular, many Master Data records may be associated with a single Configuration record, indicative of how time series may be split across many rows and tables for logical storage within a single time series manager. The start date may indicate the starting timestamp associated with all values linked to this master data record.

The Time Series Data Entity 603 may include the internal data identifier (ID), an offset (OFFSET) from the start timestamp, and a value (VALUE). Note that in the various embodiments, the value type may also vary according to the data type of the time series data configured. The internal identifier may be considered unique across all time series managers, but other embodiments can vary this practice. In some embodiments, records and fields in this entity may be created and saved as time series data is uploaded or updated via the data layer of any time series manager. Other layers that may indirectly participate in this process include the sampling layer (for example for sub-sampling the time series data) and the translation layer (for example for reading and writing bulk time series data sets in compressed binary formats). Note that, in this embodiment this entity is fully normalized and has no notion of a timestamp; instead it utilizes an offset from a reference starting timestamp, which in turn varies by the data frequency, to store the data elements. This Data entity may be linked to a corresponding Master Data entity via the ID field, which also enables translation of the offset, for any data value, back into a timestamp via the Start timestamp field of the Master Data entity. Some embodiments employ offsets to enable compact and efficient storage with the side benefit of easily accommodating sequential non-time series data that have no explicit notion of a timestamp for each data value.

The Index Data Entity 604 may include the internal distribution key (ID), and the index parameters—DIMENSIONALITY, PROJECTIONS, SIZE, SCALAR, and BUCKET WIDTH. The index data entity 604 may be used to communicate information regarding the index configuration, as shown by index configuration section 310. These may include data fields that are communicated between the layers of FIG. 1, for example from the indexing layer 110 and the view layer 104 or the visualization layer 101. The configuration layer of a time series manager may add or delete these Index Data entities while the service layer may read this information prior to configuring and launching the necessary incremental indexing jobs. As the configuration layer adds or deletes these indexes, the services layer may terminate old or launch new indexing jobs as needed. The indexing jobs in turn may leverage the indexing layer of a time series manager to update index entries.

The Index Status Data Entity 605 may include the internal distribution key (ID), a name for the index (INDEX), a beginning offset for the indexing (BEGIN), an ending offset for the indexing (END), and the current contents of the index (CONTENTS). The services layer of a time series manager may create and periodically update these entities as incremental indexing jobs are executed to index the various time series data sets. These entities may be deleted when the corresponding index configuration entries are deleted. The indexing jobs may read the prior status fields in the Index Status Data to fetch new or remaining time series data from the Data entities for incremental indexing. After each incremental indexing job iteration ends, these index status fields may be updated to reflect the incremental progress achieved.

The Sketch Data Entity (606) may include the internal distribution key (ID) and the sketch parameters—TYPE, CARDINALITY, SIZE, TOPK, WIDTH, and DEPTH. The sketch data entity 606 may be used to communicate information regarding the sketch configuration, as shown by sketch configuration section 320. These may include data fields that are communicated between the layers of FIG. 1, for example from the sketching layer 111 and the view layer 104 or the visualization layer 101. The configuration layer of a time series manager may add or delete these Sketch Data entities while the service layer reads this information prior to configuring and launching the necessary incremental sketching jobs. As the configuration layer adds or deletes these indexes, the services layer terminates old or launches new sketching jobs as needed. The sketching jobs in turn leverage the sketching layer of a time series manager to update index entries.

The Sketch Status Data Entity (607) may include the internal distribution key (ID), a name for the sketch (SKETCH), a beginning offset for the indexing (BEGIN), an ending offset for the indexing (END), and the current contents of the sketch (CONTENTS). The services layer of a time series manager may create and periodically update these entities as incremental sketching jobs are executed to sketch the various time series data sets. These entities are deleted when the corresponding sketch configuration entries are deleted. The sketching jobs may read the prior status fields in the Sketch Status Data to fetch new or remaining time series data from the Data entities for incremental sketching. After each incremental sketching job ends, these index status fields may be updated to reflect the incremental progress achieved.

The Pattern Data Entity 608 has fields that may include an internal pattern identifier key (PID), a unique name for the captured pattern (PGUID), a serial number for the pattern value (INDEX), and the pattern value itself (VALUE). The capture pattern action of some embodiments, discussed earlier in connection with FIG. 4 and interface element 415, when invoked may use the data layer of a time series manager to create or update records for this entity while the interface element 409 may be used to delete entities. Other embodiments may use automated pathways to directly leverage the data layer of a time series manager for this purpose.

The Inverted Index Data Entity (609) has fields that may include the internal distribution key (ID) with the name of the index (INDEX) at a given offset value (OFFSET). The indexing layer may create and update these entries as incremental indexing jobs may be executed across time series managers. Note that this entity may provide a lookup for an offset value given an index value in contrast to the Data entity that may use the offset to locate a specific data value; hence the use of the term “inverted” in the entity name.

The Node Status Data Entity 610 has fields that may include the logical node number (LN), the address of the node (ADDR), the node data center (DC), a name for the node (NM), a unique identifier for the node (BD), whether the node is a bootstrap node (ISBOOT), whether the node is a seed node (ISSEED), which data node the current node is a designated replica of (REPLICAOF), the type of the node (STYPE), the user data storage size (STORAGE), and the various statuses of the storage (STSTAT), indexing/sketching (ISSTAT), views (VWSTAT), overlay (OWSTAT), and the global views (GLSTAT). The node status data entity 610 may be used to communicate information regarding the status of the time series manager and/or its configuration, as shown by Views 1 and 2 on FIG. 2 above. This element may include data fields that are communicated between the layers of FIG. 1, for example from the configuration layer 106 and the view layer 104 or the visualization layer 101. The monitoring layer of a time series manager may primarily interact with this entity to create records or update fields while the visualization layer may read such entities for populating dashboards and views (for example as discussed earlier in connection with FIG. 2 interface element 215).

The data entities illustrated in FIG. 6 may not directly reveal the data type of the actual time series values in the time series data elements described. In some embodiments, a strongly typed data model is assumed and hence each of the illustrated data entities may be duplicated, once, for each type of data in the underlying implementation. Thus, there may be an integer time series data entity to store integer data while other data entities may be similarly created with varying value data types. Other embodiments may choose to employ dynamic type translations to store heterogeneous data in the data records, and may elect to employ a single set of such entities. Thus, data retrieval may also involve a translation to the underlying type of the stored data entity, facilitated by the data access and storage layers of time series managers.

Additionally, each replica set may require separate instances of all of these various entities already split by data type, since underlying implementations may choose to configure replication by entity. Thus, integer data would be stored in a different entity that is associated with one replica set as opposed to another. Hence, a substantial number of data entities may need to be managed by the storage layer of each time series manager. In some embodiments, these entities may be created or deleted depending on the data configuration. Thus, if no blob data type storage is configured for a replica set, no provision for those data entities need to be made by the storage layer. Other embodiment may choose to vary this behavior.

In some embodiments, all the view entities that are discussed next may not be stored or persisted but their records and fields may be dynamically constructed from either the provided query parameters or the underlying data entities discussed earlier. The view and overlay layers of a time series manager may primarily interact with these entities, often relaying user queries to underlying layers.

The Time Series View 611 has fields that may include the logical number where that time series is available for queries (LN), the unique user provided name (GUID), the timestamp for a specific time series value, the optional offset for that time series data value (used only for high frequency data with a resolution that exceeds that millisecond timestamp resolution provided by most systems), and the value (VALUE). Note that this entity may be derived as a combination of the underlying Time Series Data entity and the appropriate Master Data entity. The view, data access, configuration, and storage layers may mediate interactions with this entity.

The Bulk View 615 has fields that may include the node logical number (LN), the name (GUID), a starting timestamp for the bulk data range (START TIMESTAMP), the ending timestamp for the bulk data range (END TIMESTAMP), corresponding starting and ending offsets for high frequency data (START OFFSET and END OFFSET) and the serialized contents of all the time series records for the selection (CONTENTS). The view, translation, data access, and storage layers of a time series manger may mediate interactions with this entity.

The Match View has fields that may include the node logical number (LN), the node name (GUID), the timestamp of the matched value (TIMESTAMP), the optional offset for high frequency date, (OFFSET), the matched value itself (VALUE), the pattern identifier (PID from entity 808), the rank of the match (RANK), and the search radius used in the matching (RADIUS). The view, indexing, data access, and storage layers may mediate interactions with this entity.

The Sketch View has fields that may include the node logical number (LN), the name (GUID), the query value (VALUE), the sketch frequency (FREQ), and the type of the sketch (TYPE). The sketch view 613 may be used to communicate information regarding the sketch view. These may include data fields that are communicated between the layers of FIG. 1, for example from the sketching layer 111 and the view layer 104 or the visualization layer 101. The view, sketching, data access, and storage layers may mediate interactions with this entity.

The Samples View 614 has fields that include the node logical number (LN), the name (GUID), the timestamp (TIMESTAMP), the optional offset for high frequency data (OFFSET), the sampled value (VALUE), the sampling ratio (RATIO), and the type of sampling desired (TYPE). The samples view 614 may be used to communicate information regarding the samples view. These may include data fields that are communicated between the layers of FIG. 1, for example from the sampling layer 109 and the view layer 104 or the visualization layer 101. The view, sampling, data access, and storage layers of a time series manager may mediate interactions with this entity.

The Configuration Data entity, that users primarily interact with, has no knowledge of the internal data distribution or storage of the actual time series data; the Master Data entity links the user configuration information with the actual data storage entity; and the Time Series Data entity stores time series data across one or more rows keyed by an internal id field and a data offset keyed to a start value specified in the master table that varies based on the frequency of the stored data with some embodiments choosing to store a very large number of offsets as columns e.g., 1 billion or more per row of data and others using traditional row oriented storage schemas. Thus, user queries employ a series of lookups—determining the applicable the time series manager, subsequently determining the applicable master data, and finally the applicable data records to retrieve and return the complete query result. The view, configuration, data access, and storage layers may mediate interactions with this entity.

The views in FIG. 6 do not directly reveal the data type of the actual time series values in the views described. In some embodiments, a strongly typed view model is assumed and hence each of the illustrated views would be duplicated, once, for each type of data in the underlying implementation. Thus, for instance to represent integer data the “Time Series Data” Entity would be implemented as an “Integers” view that exposes the actual value as an integer while other data types would be similarly duplicated with varying value data types. Thus, this “Integers” view would appear to store all integers for all users across all time series managers in the system, highlighting a novelty of some embodiments that users do not need to create tables, schemas, and other organizational units as in traditional applications and tools, but instead simply allocate required storage in a unified single view for that data type via dynamic configuration. Other embodiments may choose to employ dynamic type translations, in the view layer, and may thus elect to employ just a single set of views.

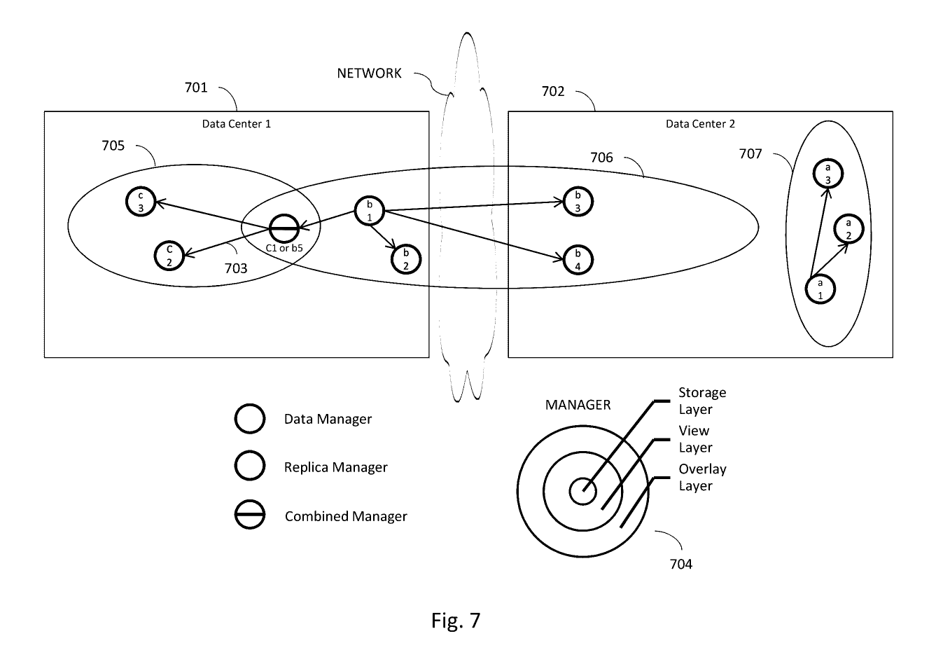

FIG. 7 is a block diagram illustrating an example of a data management scenario facilitated by a number of time series managers distributed across a pair of data centers. FIG. 7 includes a data center 1 701 that hosts a subset of the time series managers. Data center 1 701 includes time series managers b1, b2, c1 or b5, c2, and c3. In some embodiments, the replica set 705 is the set of the time series managers (c1 or b5, c2, and c3) such that each manager contains a copy of all configured time series data sets. In some embodiments, as described above, the configured time series data sets may include one or more time series data sets. Although replica set 705 may be entirely housed within data center 1, this may not typically be the case, and such sets may extend to multiple centers. In the replica set 705, the data time series manager is shown as being time series manager c1. In the data center 1 701, manager c1 or b5 is shown as a combined manager because its function as a data time series manager or a replica time series manager depends on the replica set in which you are viewing the time series manager. For replica set 706, the time series manager c1 or b5 shared between replica sets 705 and 706 is a replica time series manager (a replica of the data time series manager b1 in the replica set 706). However, in view of the replica set 705, the time series manager c1 or b5 is the data time series manager of the replica set. Thus, a combined manager may be viewed as a data time series manager or a replica time series manager dependent upon the replica set from which it is referenced.

The replica set 706 is shown spanning two data centers (data center 1 701 and data center 2 702) via the network. The network may comprise any method of communicating via wired or wireless communication protocols. For example, the network shown may include ad-hoc or peer-2-peer connections. Additionally, or alternatively, the network may comprise an enterprise network, satellite communications, the Internet, a global intranet, two nodes or time server managers connected directly together, or any data sharing communication network. The replica set 706 includes five time series managers, two in data center 2 702 and three in data center 1 701. As described above, there may be only a single data time series manager in each replica set. For replica set 706, the data time series manager is time series manager b1, while time series managers b2, b3, b4, and b5 are each replica time series managers based on the data time series manager b1. Data center 2 702 includes a second replica set that exists only within data center 2 702 and does not share any time series managers with any other replica set. The replica set 707 includes data time series manager a1 and replica time series managers a2 and a3.

The manager image 704 depicts a simplified view of the layers that provide the core storage, query, and retrieval capabilities of the time series manager, which may correspond to some of the layers shown in FIG. 1. In some embodiments, this is intended to outline the dependency of each outer layer on the inner layers, in a nested manner, such that if any layer fails, layers outside that layer may also fail; alternate embodiments can vary this structure and interpretation.

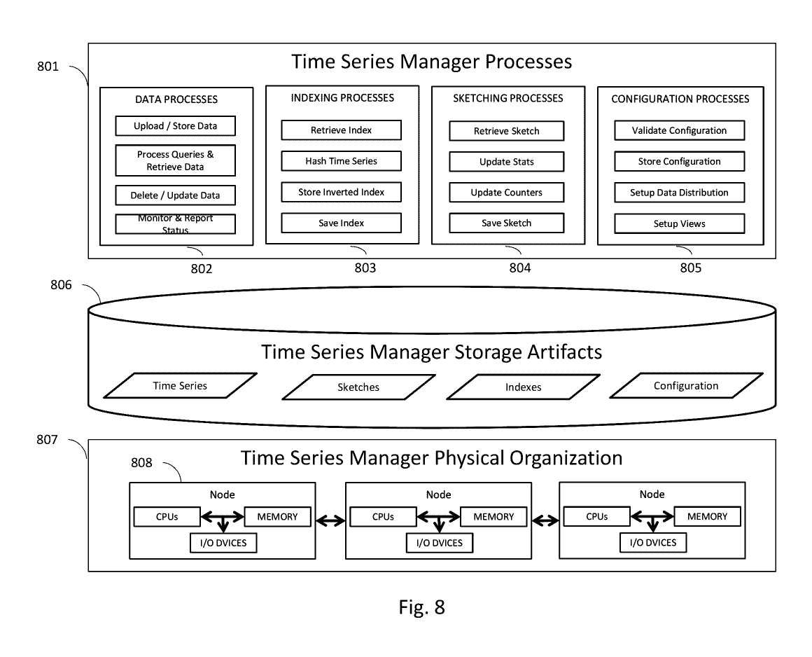

FIG. 8 is a block diagram that depicts example processes, storage artifacts, and physical organization of the time series manager. Each time series manager may include the processes 801, the storage structure 806, and the physical organization 807.

The time series manager processes 801 are divided into four subsets of processes: data processes 802, indexing processes 803, sketching processes 804, and configuration processes 805. The data processes 802 may represent the processes that may be related to the time series data within the time series manager, for example the upload/storage of data, processes associated with queries and retrieval of data, processes associated with deleting and updating data, and processes associated with monitoring and reporting data. Accordingly, the data processes 803 are associated with the time series manager's management and handling of data.

The indexing processes 803 are the processes performed and/or managed by the time series manager associated with the indexing performed by the time series manager. The indexing processes 803 include a retrieve index process, a hash time series process, a store inverted index process, and a save index process. Similarly, the sketching processes 804 include the processes performed and/or managed by the time series manager associated with sketching performed by the time series manager. These include a retrieve sketch process, an update stats process, an update counters process, and a save sketch process. These individual processes are relatively descriptive on their face and may not be further described herein. These sketching processes 805 may provide the processes necessary for the time series manager to perform the desired sketches on the target time series data sets. Finally, the configuration processes 805 may include a validate configuration process, a store configuration process, a setup data distribution process, and a setup views process. These processes may pertain more directly to establishing the configuration of the time series manager. Validate configuration process may include verification of user entitlements and the validation of user query parameters submitted for processing. The setup views process may read the configuration information, update view definitions, deduce an overlay network of relationships across the various time series managers and then use the service layer to re-publish updated the changed views to various time series managers. The data distribution process may create the master data records pertaining to a time series data configuration and the creation of any data entities specific to the replica set or data type of the time series data configuration. For instance, if a years worth of millisecond data for doubles is requested for a replica set it may create 365 master data records associated with the data time series manager of the replica set, each record corresponding to one days worth of storage. It might additionally allocate storage for each days worth of storage e.g., 2 GB.

The time series manager storage artifacts include the time series data, their configuration information, and the various indexes and sketches. The storage artifacts 806 may represent an example of the various types of data and/or information that may be stored in the storage of the time series manager. In some embodiments, all the data, indexes, and sketches corresponding to a specific configuration may be associated with a single time series manager while other embodiments may include relationships between time series managers.

Finally, the time series manager physical organization 807 provides example hardware structures for the time series managers, included at any individual node 808 that comprises a time series manager. As described above, the time series manager may include one or more nodes (or one or more time series managers). As shown in FIG. 8, the time series manager includes three nodes 808, and each of the nodes includes CPUs, memory, and 110 devices. The CPUs may correspond to the processors that perform the manipulation of the time series data sets (for example, that performs the indexing and sketching once they are respectively configured) and that updates the time series data sets (and associated indexes, sketches, samples, query results, etc.) based on the incrementally updated time series data sets, among other functions. The memory may correspond to either active memory (where operations by the processor/CPU may be performed) or memory used for storage. The I/O devices may represent sensors or other devices from which the data for the time series data sets is received and various network devices for exchanging data with other time series managers.

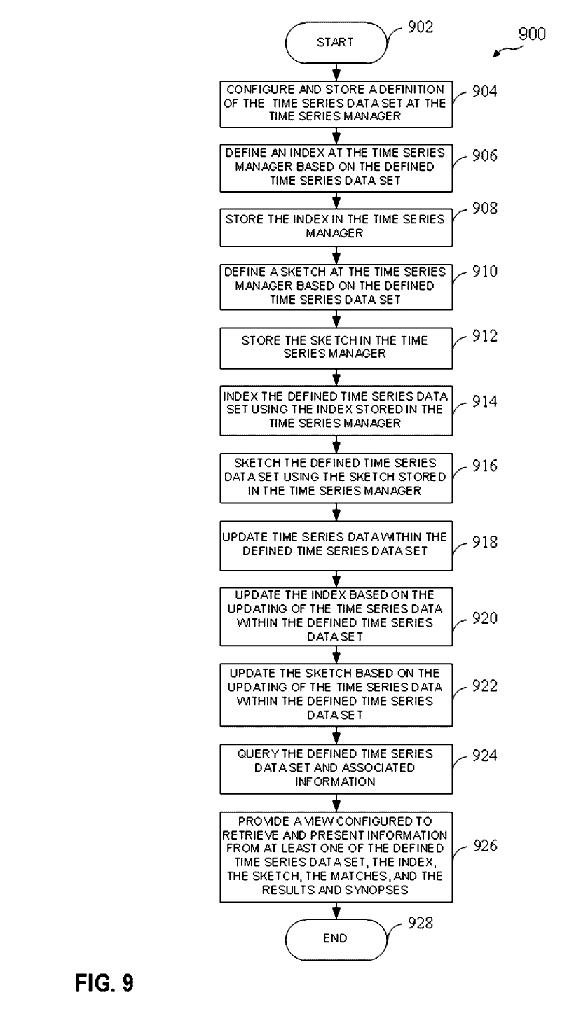

FIG. 9 depicts a flow chart for a method of managing a time series data set, in accordance with an example embodiment. According to FIG. 9, the method comprises managing time series data using a series manager; the series manager comprising a processor configured to process and store the time series data set, a memory, and a storage configured to store the time series data set. The time series data set being managed may include a plurality of time series data elements stored in the storage, wherein each of the time series data elements comprises a timestamp, a value, a context information, and a unique identifier, the unique identifier identifying the time series manager. This unique identifier may be associated with the logical identifier described above. The time series manager or system 100, as described in FIG. 1, may perform the method 900 depicted by the flow chart. The method 900 may begin at block 902 and proceed to block 904. At block 904, the first time series manager configures (defines) and stores a time series data set at the first time series manager. The configuring and storage of the time series data set may include one or more of configuring the time series data set using the data configuration item 301, as shown in FIG. 3. Before the time series data sets may be indexed, sketched, or otherwise manipulated or researched, the time series data sets may be configured to be configured and associated with the first time series manager and stored in storage. After the time series data set is configured by the first time series manager and stored in the storage, the method 900 proceeds to block 906.

At block 906, the first time series manager configures an index at the first time series manager based on the defined time series data set. The index may be configured according to the index configuration 310. The time series manager defines an index. Defining the index may comprise utilizing the index configuration section 310 as shown in FIG. 3. For example, defining the index may include selecting one defined time series data set and specifying parameters that may determine how the index is defined, as described above. Once the index is defined at block 906, the method 900 progresses to block 908, where the defined index is stored in storage (for example, the storage described in relation to FIG. 8, which may incorporate one or more of the layers of FIG. 1). After the defined index is stored, the method 900 proceeds to block 910, where the time series manager configures (defines) a sketch based on the defined time series data set. The defined sketch may be used to provide at least one of results and synopses from the defined time series data set based on user queries. In some embodiments, the defining of the sketch may utilize the sketch configuration section 320 as described above in relation to FIG. 3. Once the sketch is defined in block 910, the method 900 proceeds to block 912, where the sketch is stored in storage. The method 900 then progresses to block 914.

At block 914, the method 900 may index the defined time series data set using the index configured in block 906 and stored in the storage. In some embodiments, the indexing may occur automatically once the index is configured in block 906, while in other embodiments, the index may be applied to the time series data set such that the data set is indexed. Once the defined time series data set is indexed, the method 900 proceeds to block 916. At block 916, the method 900 may sketch the defined time series data set using the index configured in block 910 and stored in the storage. In some embodiments, the sketching may occur automatically once the sketch is configured in block 910, while in other embodiments, the sketch may be applied to the time series data set such that the data set is sketched manually (when commanded or instructed to do so). Once the defined time series data set is sketched, the method 900 proceeds to block 918. At block 918, the method 900 updates data within the defined time series data set stored in the storage. This may comprise a real-time update that occurs as soon as the updated data is received, for example, from a sensor that is currently in the process of acquiring data. In some embodiments, the real-time update may comprise adding data to an existing defined time series data set, while in some embodiments, the real-time update may comprise replacing data within an existing defined time series data set. The update may comprise one or more data elements that are to be added, replaced, or deleted within the defined time series data set. Once the time series data set is updated, the method 900 proceeds to block 920, where the index is updated. As described above, when time series data associated with a configured index is updated, the index should be updated so as to reflect the most up-to-date information and to maintain the ability to provide instantaneous data retrieval. Once the index is updated, the method 900 proceeds to block 922 and updates the sketch in real-time, similar to the index and for similar reasons. In some embodiments, updating the index and the sketch may also include saving the updated index and sketch in the storage. Once the sketch is updated, the method proceeds to block 924.

At block 924, the method 900 queries the defined time series data set and associated information (for example, sketches, indexes, samples, etc.). In some embodiments, the query may be based on at least one of the index and the sketch. In some embodiments, the query may be a user query or a query provided by any entity configured to interact with the system. In some embodiments, the query may further include queries of the defined time series data set, samples, or other information that may be obtained from the defined time series data set or manipulation of the defined time series data set. Once the query has been applied to the defined time series data, the method 900 proceeds to block 926. At block 926, the method 900 provides a view configured to retrieve and present information from at least one of the defined time series data set, the index, the sketch, the matches, and the results and synopses. In some embodiments, the view may further provide any information that may be obtained from the defined time series data set, with or without manipulation. In some embodiments, the providing of the view may be dependent upon the selections of the interface depicted in FIG. 2 and/or FIGS. 3-5. In some embodiments, the view provided by block 924 may correspond to the view generated by the view and/or visualization layers of FIG. 100. Providing the view may include providing the views to a user or an enterprise system for monitoring, etc. Once the view is generated, the method 900 ends.

In some embodiments, the various blocks described above in relation to the method 900 may be performed by a processor (as shown in FIG. 8) or via one or more I/O devices (as shown in FIG. 8). Alternatively, or additionally, one or more of the blocks of the method 900 may be performed by a user (for example, the configuration of the data, index, or sketch) or automatically by the processing systems of the time series manager (for example, a processor).

The various operations of methods described above may be performed by any suitable means capable of performing the operations, such as various hardware and/or software component(s), circuits, and/or module(s). Generally, any operations illustrated in the Figures may be performed by corresponding functional means capable of performing the operations. For example, a means for configuring a definition of the time series data set may comprise a time series manager 704 (FIG. 7), time series manager 100 (FIG. 1), or associated with the configuration layer 106. In addition, means for storing the defined time series data set may comprise a memory or a storage, for example memory in FIG. 8 or associated with the storage layer 112 in FIG. 1. The means for defining an index based on the defined time series data set may include the CPUs (FIG. 8), the time series manager 704 (FIG. 7), or may be associated with the indexing layer 110. In addition, means for storing the index may comprise the memory or the storage, for example memory in FIG. 8 or associated with the storage layer 112 or sketching layer 111 in FIG. 1. The means for defining a sketch based on the defined time series data set may include the CPUs (FIG. 8), the time series manager 704 (FIG. 7), the sketching configuration 320 or 501, or may be associated with the sketching layer 111. In addition, means for storing the sketch may comprise the memory or the storage, for example memory in FIG. 8 or associated with the storage layer 112 or sketching layer 111 in FIG. 1 in FIG. 1. Means for indexing may include the processor or CPUs described above, the data and view structures 604, or may be associated with the indexing layer 110. Means for indexing may include the processor or CPUs described above, the data and view structures 606 and 613, or may be associated with the sketching layer 111. Means for updating the data, the index, and the query may include the processor or CPUs described above or the data and view structures, for example structures 601, 604, 606, 613, 611, and 612. Additionally, the means for querying may comprise the processor or CPUs discussed above, the various configuration screens, or may be associated various layers in the FIG. 1, including the services layer 103, the data access layer 105, etc. The means for providing a view may comprise a monitor or other component configured to display outputs for user use or may be associated with the visualization, overlay, and view layers 101, 102, and 104, respectively.

The various operations of methods described above may be performed by any suitable means capable of performing the operations, such as various hardware and/or software component(s), circuits, and/or module(s). Generally, any operations illustrated in the Figures may be performed by corresponding functional means capable of performing the operations. For example, a means for selectively switching communication may comprise a first network switch. In addition, means for communicating with a device may comprise a transmitter or a receiver.

Information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, communication signals, wireless networks, communication fields, communication networks, or any combination thereof.

The various illustrative logical blocks, modules, circuits, and algorithm steps described in connection with the implementations disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. The described functionality may be implemented in varying ways for each particular application, but such implementation decisions may not be interpreted as causing a departure from the scope of the implementations of the invention.

The various illustrative blocks, modules, and circuits described in connection with the implementations disclosed herein may be implemented or performed with a general purpose processor, a Digital Signal Processor (DSP), an Application Specific Integrated Circuit (ASIC), a Field Programmable Gate Array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm and functions described in connection with the implementations disclosed herein may be embodied directly in hardware, in a software module executed by a processor, or in a combination of the two. If implemented in software, the functions may be stored on or transmitted over as one or more instructions or code on a tangible, non-transitory computer-readable medium. A software module may reside in Random Access Memory (RAM), flash memory, Read Only Memory (ROM), Electrically Programmable ROM (EPROM), Electrically Erasable Programmable ROM (EEPROM), registers, hard disk, a removable disk, a CD ROM, or any other form of storage medium known in the art. A storage medium is coupled to the processor such that the processor may read information from, and write information to, the storage medium. In the alternative, the storage medium may be integral to the processor. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above may also be included within the scope of computer readable media. The processor and the storage medium may reside in an ASIC. The ASIC may reside in a user terminal. In the alternative, the processor and the storage medium may reside as discrete components in a user terminal.

For purposes of summarizing the disclosure, certain aspects, advantages and novel features of the inventions have been described herein. It is to be understood that not necessarily all such advantages may be achieved in accordance with any particular implementation of the invention. Thus, the invention may be embodied or carried out in a manner that achieves or optimizes one advantage or group of advantages as taught herein without necessarily achieving other advantages as may be taught or suggested herein.

Various modifications of the above-described implementations will be readily apparent, and the generic principles defined herein may be applied to other implementations without departing from the spirit or scope of the invention. Thus, the present invention is not intended to be limited to the implementations shown herein but is to be accorded the widest scope consistent with the principles and novel features disclosed herein.

What is claimed is:

1. A system for managing a time series data set, the time series data set including a plurality of time series data elements, each time series data element comprising a timestamp, a value, and a context information, the system comprising:
a time series manager comprising:
a processor configured to manage a defined time series data set;
a memory; and
a storage configured to store the defined time series data set;
wherein the time series manager is individually identified by a unique identifier, and configured to:
define a defined time series data set, the defined time series data set including the plurality of time series data elements, each time series data element further comprising the unique identifier;
define an index based on the defined time series data set, wherein the index is used to identify matches of a query within the defined time series data set;
store the index in the time series manager;
define a sketch based on the defined time series data set, wherein the sketch is used to provide results and synopses from the defined time series data set based on the query;
store the sketch in the time series manager;
query the defined time series data set and associated information;
insert, update, or delete a single data element, or a batch of data elements, within the defined time series data set stored in the time series manager, wherein the insert, update, or delete causes the index and sketch to be updated in real-time, and
provide a view configured to retrieve and present information from at least one of the defined time series data set, the index, the sketch, the matches, and the results and synopses, wherein the defined time series data set, the index, the sketch, the matches, and the results and synopses are updated in real-time.

2. The system of claim 1, wherein the time series manager comprises one of a plurality of time series managers and one or more nodes.

3. The system of claim 1, wherein the time series manager and another time series manager in combination form a replication set and wherein the time series manager and the other time series manager that in combination form the replication set share at least the defined time series data set.

4. The system of claim 3, wherein the replication set is configured to be deployed in a single data center, in a plurality of data centers, within a single level of a hierarchy of time series managers, or across a plurality of levels within the hierarchy of time series managers.

5. The system of claim 3, wherein the replication set is formed based on the unique identifier and wherein the other time series manager includes copies of all defined time series data sets of the time series manager having the unique identifier.

6. The system of claim 1, wherein the time series manager is further configured to perform multi-dimensional query retrieval of the defined time series data set and wherein performing multi-dimensional query retrieval comprises searching the defined time series data set for a subset of time series data elements.

7. The system of claim 6, wherein the searching of the defined time series data set for the subset of time series data elements comprises searching the defined time series data set for a matching subset of time series data elements within a degree of the subset of time series data elements, as defined by statistical analysis.

8. The system of claim 6, wherein the multi-dimensional query retrieval performing further comprises performing a search on a plurality of defined time series data sets based on the subset of time series data elements to identify corresponding events across the plurality of defined time series data sets.

9. The system of claim 1, wherein the view is further configured to retrieve and present at least one of exact and approximate information, based on the query, from any time series manager of any level of a plurality of levels of a hierarchy of times series managers, wherein the hierarchy of time series managers includes the time series manager and wherein at least one time series manager of the hierarchy of time series managers comprises one other time series manager, by querying either the defined time series data set or by using a sample or the sketch, wherein the sample is used to provide a summary of the defined time series data set, and wherein the defined time series data set, the index, the sketch, the matches, and the results and synopses are updated in real-time while the view is provided.

10. The system of claim 1, wherein the updating data comprises at least one of replacing, adding, and deleting one or more time series data elements within the defined time series data set stored in the time series manager.

11. A method of managing a time series data set using a time series manager identified by a unique identifier and comprising a processor configured to process and store the time series data set, a memory, and a storage configured to store the time series data set, wherein the time series data set includes a plurality of time series data elements stored in the storage, each of the time series data elements comprising a timestamp, a value, a context information, and the unique identifier, the method comprising:
configuring a definition of the time series data set by the time series manager;
storing the defined time series data set in the storage;
defining an index, via the time series manager, based on the defined time series data set, wherein the index is used to identify matches of a user query pattern within the defined time series data set;
storing the index in the time series manager;
defining a sketch based on the defined time series data set, wherein the sketch is used to provide at least one of results and synopses from the defined time series data set based on user queries;
storing the sketch in the time series manager;
indexing the defined time series data set using the index stored in the time series manager;
sketching the defined time series data set using the sketch stored in the time series manager;
updating data within the defined time series data set stored in the time series manager;
updating the index based on the updating of the data within the defined time series data set;
updating the sketch based on the updating of the data within the defined time series data sets;
querying the defined time series data set and associated information; and
providing a view configured to retrieve and present information from at least one of the time series data set, the index, the sketch, the matches, and the results and synopses.

12. The method of claim 11, wherein the time series manager comprises one of a plurality of time series managers and one or more nodes.

13. The method of claim 11, further configured to form a replication set with the time series manager and another time series manager in combination, wherein the time series manager and the other time series manager that in combination form the replication set share at least the defined time series data set.

14. The method of claim 13, further comprising deploying the replication set in a single data center, in a plurality of data centers, within a single level of a hierarchy of time series managers, or across a plurality of levels within the hierarchy of time series managers.

15. The method of claim 13, wherein the replication set is formed based on the unique identifier and wherein the other time series manager includes copies of all defined time series data sets of the time series manager having the unique identifier.

16. The method of claim 11, further comprising performing multi-dimensional query retrieval of the defined time series data set, wherein performing multi-dimensional query retrieval comprises searching the defined time series data set for a subset of time series data elements.

17. The method of claim 16, wherein the searching of the defined time series data set for the subset of time series data elements comprises searching the defined time series data set for a matching subset of time series data elements within a degree of the subset of time series data elements, as defined by statistical analysis.

18. The method of claim 16, wherein the multi-dimensional query retrieval performing further comprises performing a search on a plurality of defined time series data sets based on the subset of time series data elements to identify corresponding events across the plurality of defined time series data sets.

19. The method of claim 11, further comprising retrieving and presenting at least one of exact and approximate information, based on the query, from any time series manager of any level of a plurality of levels of a hierarchy of times series managers, wherein the hierarchy of time series managers includes the time series manager and wherein at least one time series manager of the hierarchy of time series managers comprises one other time series manager, by querying either the defined time series data set or by using a sample or the sketch, wherein the sample is used to provide a summary of the defined time series data set, and wherein the defined time series data set, the index, the sketch, the matches, and the results and synopses are updated in real-time while the view is provided.

20. A non-transitory computer readable medium have stored thereon instructions that, when executed, cause a computing environment to perform a method of managing a time series data set using a time series manager identified by a unique identifier and comprising a processor configured to process and store the time series data set, a memory, and a storage configured to store the time series data set, wherein the time series data set includes a plurality of time series data elements stored in the storage, each of the time series data elements comprising a timestamp, a value, a context information, and the unique identifier, the method comprising:
configuring a definition of the time series data set by the time series manager;
storing the defined time series data set in the storage;
defining an index, via the time series manager, based on the defined time series data set, wherein the index is used to identify matches of a user query pattern within the defined time series data set;
storing the index in the time series manager;
defining a sketch based on the defined time series data set, wherein the sketch is used to provide at least one of results and synopses from the defined time series data set based on user queries;
storing the sketch in the time series manager;
indexing the defined time series data set using the index stored in the time series manager;
sketching the defined time series data set using the sketch stored in the time series manager;
updating data within the defined time series data set stored in the time series manager;
updating the index based on the updating of the data within the defined time series data set;
updating the sketch based on the updating of the data within the defined time series data sets;
querying the defined time series data set and associated information; and
providing a view configured to retrieve and present information from at least one of the time series data set, the index, the sketch, the matches, and the results and synopses.
